(19) United States
(12) Patent Application Publication
(10) Pub. No.: US 2016/0236172 A1
(43) Pub. Date: Aug. 18, 2016

(54) Absorbent Fibrous Structures Comprising a Soil Absorbing Agent and a Detackifier

(71) Applicant: The Procter & Gamble Company, Cincinnati, OH (US)

(72) Inventors: Thomas James Klofta, Cincinnati, OH (US); Cahit E. Eylem, West Chester, OH (US); Michael Scott Prodoehl, West Chester, OH (US); David Dale McKay, Wilmington, OH (US); David Warren Loebker, Cincinnati, OH (US)

(73) Assignee: The Procter & Gamble Company

(21) Appl. No.: 15/045,288

(22) Filed: Feb. 17, 2016

Related U.S. Application Data
(60) Provisional application No. 62/117,612, filed on Feb. 18, 2015.

(51) Int. Cl. B01J 20/26; B01J 20/24; C11D 3/12; C11D 17/04; C11D 3/37; C11D 3/20

(52) U.S. Cl. CPC B01J 20/261; C11D 3/3773; C11D 3/2093; C11D 3/1266; C11D 17/049; B01J 20/24

(57) ABSTRACT

Absorbent fibrous structures containing a soil adsorbing agent and a detackifier, and methods for making same are provided.

### FIELD OF THE INVENTION

The present invention relates to fibrous structures, for example absorbent fibrous structures and more particularly to absorbent fibrous structures comprising a soil adsorbing agent, for example an emulsion comprising a soil adsorbing agent, and a detackifier, present within or outside of the emulsion comprising the soil adsorbing agent, and methods for making same.

### BACKGROUND OF THE INVENTION

Fibrous structures comprising a soil adsorbing agent, for example an emulsion comprising a soil adsorbing agent, are known in the art. However, it has been found that the current soil adsorbing agents can exhibit an adhesive (tacky) sensorial feel to consumers during use, especially during hand drying with the fibrous structures, such as paper towels. In addition to the negative sensorial issues, the current processes for producing the known fibrous structures comprising soil adsorbing agents, for example emulsions comprising soil adsorbing agents, utilize high levels of soil adsorbing agents, for example 50% or more by weight, which creates processing negatives on rollers, belts, and other equipment when applying the soil adsorbing agent to a fibrous structure during the fibrous structure making and/or converting processes. One major issue with the use of high levels of soil adsorbing agents is hard buildup on rollers, which creates web handling issues such as loss of web control and/or loss of traction of the web during the application of the soil adsorbing agent from the applicator through log winding in a fibrous structure converting line. Another issue with the use of high levels of soil adsorbing agents is clogging of delivery equipment, such as slot extruders, and/or non-uniform delivery of the soil adsorbing agents during application to the fibrous structures. Still yet another issue with the use of high levels of soil adsorbing agents is the clogging of perforation blades. In general, the high levels of soil adsorbing agents creates a sticky mess throughout the application and winding process, especially on the equipment that the treated fibrous structure contacts.

One problem with current fibrous structures comprising an emulsion comprising a soil adsorbing agent is that the soil adsorbing agent exhibits an adhesive (tacky) sensorial feel to consumers during use of the fibrous structures, especially during hand drying with the fibrous structures. In addition, current processes for making such fibrous structures comprising an emulsion comprising a soil adsorbing agent using high levels (50% or greater by weight) creates significant hygiene issues and absorbency negatives as described above.

Due to the fact that some if not all classes of detackifiers are oftentimes considered to be dirt or soil applying such detackifiers in an aqueous solution to the emulsion comprising the soil adsorbing agent and/or or onto a fibrous structure treated with a soil adsorbing agent can negatively impact the soil adsorbing agent's soil adsorption properties and/or mirror cleaning properties. Without wishing to be bound by theory, it is believe that at least portions of the detackifier are adsorbed by the soil adsorbing agent and/or any aqueous carrier for the detackifier may prematurely activate the soil adsorbing agent thus rendering the soil adsorbing agent inactive or less active for later use.

Accordingly, there is a need for a fibrous structure comprising an emulsion comprising a soil adsorbing agent that doesn't exhibit the negatives described above; namely, doesn't exhibit an adhesive (tacky) sensorial feel to consumers during use, especially during hand drying with the fibrous structure, but retains its soil adsorbing and/or mirror cleaning functions and/or doesn't significantly negatively impact the soil adsorbing agent's soil adsorbing and/or mirror cleaning functions, and optionally, doesn't create or mitigates hygiene issues during the making of such fibrous structures.

### SUMMARY OF THE INVENTION

The present invention fulfills the needs described above by providing a fibrous structure comprising an emulsion comprising a soil adsorbing agent and a detackifier that overcomes the negatives described above and is made by a process that overcomes the hygiene issues described above.

One solution to the problem identified above is a fibrous structure comprising a soil adsorbing agent, for example a copolymer, such as a branched copolymer, that adsorbs soil as measured according to the Soil Adsorption Test Method, described herein, and a detackifier, a material that reduces tackiness of other materials, for example the soil adsorbing agent. The soil adsorbing agent and detackifier may be present on and/or applied to a surface of the fibrous structure in the form of an emulsion (a dispersion of droplets of oil-in-water), such as a dewatered emulsion, and/or may be present on and/or applied to a surface of the fibrous structure as two separate, discrete components, for such as in a “side-by-side” arrangement and/or where the soil adsorbing agent is positioned between the surface of the fibrous structure and the detackier such that the detackifier comes into contact with a user's skin prior to or instead of the soil adsorbing agent. The presence of the detackifier eliminates and/or mitigates the tacky nature of the soil adsorbing agent as experienced by consumers during use of a fibrous structure with the soil adsorbing agent (without the detackifier), without significantly negatively impacting the soil adsorbing agent's soil adsorbing and/or mirror cleaning functions. In addition, the addition of a detackifier to the soil adsorbing agent emulsion and/or onto the fibrous structure eliminates and/or mitigates the processing and/or fibrous structure property negatives, for example hygiene issues. It has been found that adding a detackifier, for example at certain levels and/or particle counts and/or type of detackifier, eliminates and/or mitigates the adhesive (tacky) sensorial feel, absorbency negatives, and/or hygiene issues associated with using and/or making fibrous structures comprising an emulsion, for example a dewatered emulsion, comprising a soil adsorbing agent, for example a copolymer, such as a branched copolymer, without significantly negatively impacting the soil adsorbing agent's soil adsorbing and/or mirror cleaning functions.

It has unexpectedly been found that adding detackifiers, which include clays, often times considered “dirt” and/or “soil”, to systems, for example emulsions, comprising a soil adsorbing agent, does not inactivate the soil adsorbing and/or mirror cleaning functions of the soil adsorbing agent, especially when present on a fibrous structure, for example an absorbent fibrous structure. It has been found that the dewatered state of the soil adsorbing agent, for example the dewatered soil adsorbing agent polymer particle prevents and/or mitigates the total level of soil adsorbing agent from being activated and thus adsorbing the detackifier, which would render the soil adsorbing agent inactive for its soil adsorbing and/or mirror cleaning purpose; namely, to adsorb soil and/or clean mirrors when a consumer uses the fibrous structure comprising the soil adsorbing agent.

In one example of the present invention, a fibrous structure, for example an absorbent fibrous structure, for example a dry absorbent fibrous structure, comprising a soil adsorbing agent, for example a copolymer, such as a branched copolymer, and a detackifier, for example an inorganic and/or organic detackifier, is provided.

In another example of the present invention, a fibrous structure, for example an absorbent fibrous structure, for example a dry absorbent fibrous structure, comprising an emulsion, for example a dewatered emulsion, comprising a soil adsorbing agent, for example a copolymer, such as a branched copolymer, and a detackifer, for example an inorganic and/or an organic detackifier, is provided.

In still another example of the present invention, a single- or multi-ply sanitary tissue product comprising a fibrous structure, for example an absorbent fibrous structure, for example dry fibrous structure, according to the present invention is provided.

In yet another example of the present invention, a method for making a fibrous structure, for example an absorbent fibrous structure, for example dry absorbent fibrous structure, comprising the step of contacting an absorbent fibrous structure with an emulsion, for example a dewatered emulsion comprising a soil adsorbing agent, for example a copolymer, such as a branched copolymer, and a detackifier, for example an inorganic and/or an organic detackifier, is provided.

In yet another example of the present invention, a method for making a fibrous structure, for example an absorbent fibrous structure, for example dry absorbent fibrous structure, comprising the steps of contacting a fibrous structure, for example an absorbent fibrous structure with an emulsion, for example a dewatered emulsion comprising a soil adsorbing agent, for example a copolymer, such as a branched copolymer; and contacting the fibrous structure, with a detackifier, for example an inorganic and/or an organic detackifier, for example a detackifier in a carrier fluid, such as a hydrocarbon fluid, for example oil, which may be miscible with the continuous phase, for example hydrocarbon, of the emulsion comprising the soil adsorbing agent, is provided.

In still another example of the present invention, an emulsion comprising a soil adsorbing agent, for example a copolymer, such as a branched copolymer, a detackifier, for example an inorganic and/or an organic detackifier, and a hydrocarbon fluid, such as an oil, is provided.

In still yet another example of the present invention, a method for making an emulsion comprising the step of mixing a soil adsorbing agent, for example a copolymer, such as a branched copolymer, and a detackifier, for example an inorganic and/or an organic detackifier, with a hydrocarbon fluid, such as an oil, to form an emulsion is provided.

The present invention provides novel fibrous structures, for example novel absorbent fibrous structures, for example novel dry absorbent fibrous structures, comprising a soil adsorbing agent, for example a copolymer, such as a branched copolymer, and a detackifier, for example an inorganic and/or an organic detackifier, such as an emulsion of the soil adsorbing agent and detackifier, an emulsion comprising a soil adsorbing agent, for example a copolymer, such as a branched copolymer, and a detackifier, for example an inorganic and/or an organic detackifier, and methods for making same.

### BRIEF DESCRIPTION OF THE DRAWINGS

FIG. 1A is a schematic representation of an example of a fibrous structure according to the present invention;

FIG. 1B is a schematic representation of another example of a fibrous structure according to the present invention;

FIG. 2 is a plot of the Probe Tack Sticky Energy Value vs. Soil Adsorbing Agent (Polyacrylamide-Hyperfloc® from SNF) Add-on Level of fibrous structures, both with and without detackifiers;

FIG. 3 is a plot of the Soil Adsorption Value (Soil Retention Value) vs. Soil Adsorbing Agent (Polyacrylamide-Hyperfloc® from SNF) Add-on Level of fibrous structures, both with and without detackifiers;

FIG. 4 is a plot of the Average Mirror Cleaning Value vs. Soil Adsorbing Agent (Polyacrylamide-Hyperfloc® from SNF) Add-on Level of fibrous structures, both with and without detackifiers; and

FIG. 5 is a plot of the Mirror Cleaning Value of Mirror 2 vs. Soil Adsorbing Agent (Polyacrylamide-Hyperfloc® from SNF) Add-on Level of fibrous structures, both with and without detackifiers;

FIG. 6 is a schematic representation of a sample of fibrous structure used in the Mirror Cleaning Test Method described herein;

FIG. 7 is a schematic representation of 9 individual spectrodensitometer measurement spots on a surface of a mirror for the Mirror Cleaning Test Method;

FIGS. 8 and 8A are diagrams of a support rack utilized in the CRT Test Method described herein;

FIGS. 9 and 9A are diagrams of a support rack cover utilized in the CRT Test Method described herein; and

### DETAILED DESCRIPTION OF THE INVENTION

### Definitions

“Fibrous structure” as used herein means a structure that comprises one or more fibrous filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid processes, such as wet-laid papermaking processes, and air-laid processes, such as air-laid papermaking processes. Wet-laid and/or air-laid papermaking processes typically include a step of preparing a composition comprising a plurality of fibers that are suspended in a medium, either wet, more specifically aqueous medium, or dry, more specifically gaseous medium, such as air. The aqueous medium used for wet-laid processes is oftentimes referred to as a fiber slurry. The fiber composition is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

Non-limiting examples of other known processes and/or unit operations for making fibrous structures include fabric crepe and/or belt crepe processes, ATMOS processes, NTT processes, through-air-dried processes, uncreped through-air-dried processes, and conventional wet press processes.

Another process that can be used to produce the fibrous structures is a melt-blowing, dry spinning, and/or spunbonding process where a polymer composition is spun into filaments and collected on a belt to produce a fibrous structure. In one example, a plurality of fibers may be mixed with the filaments prior to collecting on the belt and/or a plurality of fibers may be deposited on a prior produced fibrous structure comprising filaments.

The fibrous structures of the present invention may be homogeneous or may be layered in the direction normal to the machine direction. If layered, the fibrous structures may comprise at least two and/or at least three and/or at least four and/or at least five layers.

The fibrous structures of the present invention may be co-formed fibrous structures. “Co-formed” as used herein means that the fibrous structure comprises a mixture of at least two different components wherein at least one of the components comprises a filament, such as a polypropylene filament, and at least one other component, different from the first component, comprises a solid additive, such as a fiber and/or a particulate. In one example, a co-formed fibrous structure comprises solid additives, such as fibers, such as wood pulp fibers and/or absorbent gel articles of manufacture and/or filler particles and/or particulate spot bonding powders and/or clays, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of articles of manufacture that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories as well as other non-fibrous articles of manufacture such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Absorbent fibrous structure” as used herein means a fibrous structure absorbs water.

“Dry web” as used herein means a web that comprises less than 30% and/or less than 20% and/or less than 15% and/or less than 10% and/or less than 7% and/or less than 5% and/or less than 3% and/or less than 2% and/or less than 1% and/or less than 0.5% by weight of moisture as measured according to the Moisture Content Test Method described herein.

“Dry absorbent fibrous structure” as used herein means an absorbent fibrous structure that comprises less than 30% and/or less than 20% and/or less than 15% and/or less than 10% and/or less than 7% and/or less than 5% and/or less than 3% and/or less than 2% and/or less than 1% and/or less than 0.5% by weight of moisture as measured according to the Moisture Content Test Method described herein.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), multi-functional absorbent and cleaning uses (absorbent towels), and folded sanitary tissue products such as napkins and/or facial tissues including folded sanitary tissue products dispensed from a container, such as a box. The sanitary tissue product may be convolutedly wound upon itself about a core or without a core to form a sanitary tissue product roll.

In one example, the sanitary tissue product of the present invention comprises a fibrous structure according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m² as measured according to the Basis Weight Test Method described herein In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m² as measured according to the Basis Weight Test Method described herein.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets. In one example, one or more ends of the roll of sanitary tissue product may comprise an adhesive and/or dry strength agent to mitigate the loss of fibers, especially wood pulp fibers from the ends of the roll of sanitary tissue product.

The sanitary tissue products of the present invention may comprises additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and absorbency aids.

“Basis Weight” as used herein is the weight per unit area of a sample reported in lbs/3000 ft² or g/m² and is measured according to the Basis Weight Test Method described herein.

“By weight of moisture” or “moisture content” means the amount of moisture present in an article of manufacture measured according to the Moisture Content Test Method described herein immediately after the article of manufacture has been conditioned in a conditioned room at a temperature of 73° F.±4° F. (about 23° C.±2.2° C.) and a relative humidity of 50%±10% for 24 hours.

“Water-soluble” as used herein means a material, such as a polymer, for example a soil adsorbing polymer that is miscible in water. In other words, a material that is capable of forming a stable (does not separate for greater than 5 minutes after forming the homogeneous solution) homogeneous solution with water at ambient conditions (about 23° C. and a relative humidity of about 50%).

“Machine Direction” or “MD” as used herein means the direction parallel to the flow of the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

### Fibrous Structure

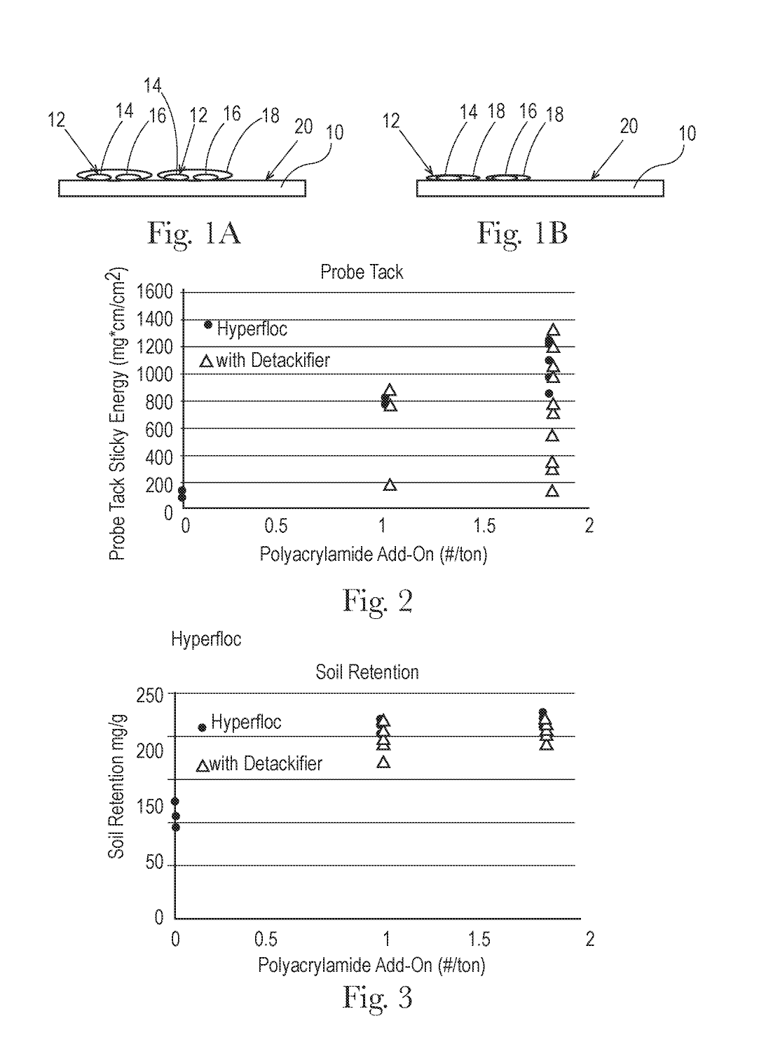

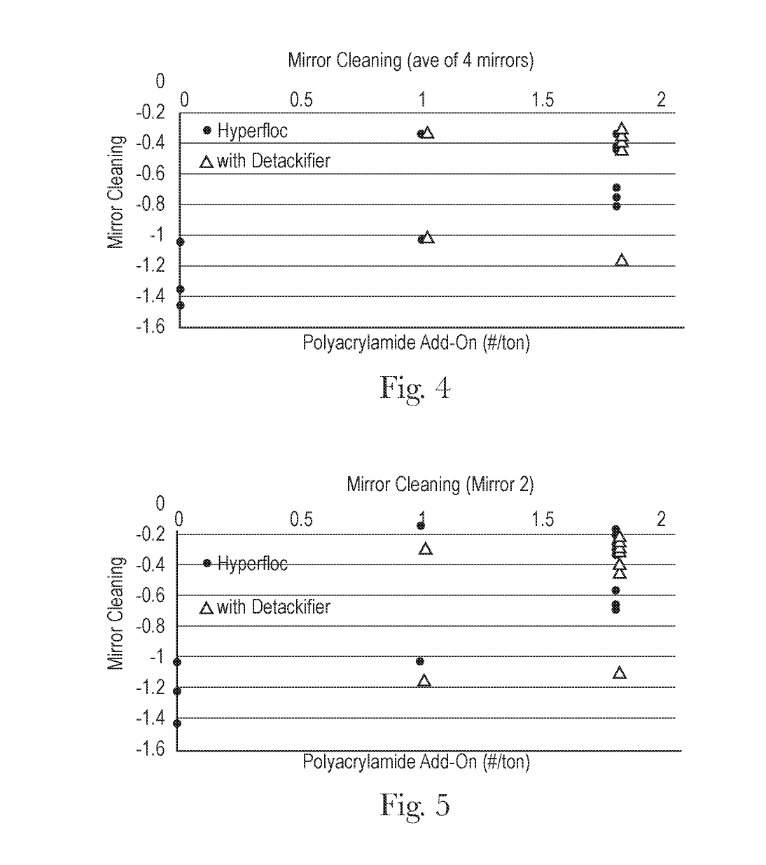

In one example of the present invention as shown in FIGS. 1A and 1B, the fibrous structure 10, for example absorbent fibrous structure, comprises a soil adsorbing agent 12, such as a copolymer, for example a branched copolymer, which may be in the form of a polymer particle 14, for example a water-soluble soil adsorbing particle, and a detackifer 16, for example an inorganic and/or an organic detackifier. As shown in FIG. 1A, the soil adsorbing agent 12 and detackifier 16 may be present in a hydrocarbon fluid 18 in the form of an emulsion comprising the soil adsorbing agent 12, detackifier 16, and hydrocarbon fluid 18. The fibrous structure 10 of FIG. 1A may be made by applying to a surface 20 of the fibrous structure 10 an emulsion comprising the soil adsorbing agent 12, the detackifier 16, and a hydrocarbon fluid 18, such as an oil. In addition, the emulsion may further comprise one or more surfactants, such as an inverting surfactants and/or emulsifying surfactants. Further yet, the emulsion may be an inverse emulsion (a dispersion of droplets of water-in-oil), a dewatered emulsion and/or an inverse dewatered emulsion.

As shown in FIG. 1B, the soil adsorbing agent 12 and detackifier 16 may be present as separate, discrete components. The fibrous structure 10 of FIG. 1B may comprise a soil adsorbing agent 12, such as a copolymer, for example a branched copolymer, which may be in the form of a polymer particle 14, for example a water-soluble soil adsorbing particle, in an emulsion 20 comprising a hydrocarbon fluid 18, such as an oil, and the detackifier 16 may be in another emulsion 20 or carrier, such as a hydrocarbon fluid 18, such as an oil, and/or may be neat. The fibrous structure 10 of FIG. 1B may be made by applying to a surface 22 of the fibrous structure 10 an emulsion 20 comprising the soil adsorbing agent 12 and a hydrocarbon fluid 18, such as an oil, and applying to the surface 22 of the fibrous structure 10 an emulsion 20 or carrier, such as a hydrocarbon fluid 18, such as an oil, and/or may be neat. In addition, the emulsion 20 may further comprise one or more surfactants, such as a inverting surfactants and/or emulsifying surfactants. Further yet, the emulsion 20 may be an inverse emulsion, a dewatered emulsion and/or an inverse dewatered emulsion.

In one example, the fibrous structure, for example absorbent fibrous structure, for example a dry absorbent fibrous structure, comprises a dewatered emulsion comprising a soil adsorbing agent, for example a branched copolymer soil adsorbing agent, for example a plurality of water-soluble soil adsorbing branched copolymer particles, a detackifier, for example an inorganic detackifier and/or an organic detackifier, and a hydrocarbon fluid, for example a hydrocarbon fluid that exhibits a VOC content of less than 60% as measured according to the VOC Test Method described herein.

In one example of the present invention, the fibrous structure, for example absorbent fibrous structure, for example a dry absorbent fibrous structure, comprises a soil adsorbing agent, such as a copolymer, for example a branched copolymer, for example a plurality of water-soluble soil adsorbing particles, and a detackifer, for example an inorganic and/or an organic detackifier. The soil adsorbing agent, with or without the detackifier, may be present as an emulsion comprising a hydrocarbon fluid, for example an oil, as the continuous phase, for example a dewatered emulsion, such as an inverted, dewatered emulsion. The hydrocarbon fluid, for example an oil, when present, may exhibit a VOC content of less than 60% as measured according to the VOC Test Method described herein. In addition, the fibrous structure, for example absorbent fibrous structure, for example a dry absorbent fibrous structure, comprises a soil adsorbing agent, such as a copolymer, for example a branched copolymer, for example a plurality of water-soluble soil adsorbing particles, and a detackifer, for example an inorganic and/or an organic detackifier. The soil adsorbing agent and/or detackifier may both be present as emulsions, for example a dewatered emulsion, such as an inverted, dewatered emulsion, and/or the detackifier may be present in a carrier, comprising a hydrocarbon fluid, for example an oil, as the continuous phase. The hydrocarbon fluid, for example an oil, when present, may exhibit a VOC content of less than 60% as measured according to the VOC Test Method described herein.

In one example, the fibrous structure, for example absorbent fibrous structure of the present invention comprises a dry absorbent fibrous structure such as a dry paper towel, rather than a pre-moistened, liquid composition-containing towel or wipe or pad.

In one example, the fibrous structure, for example absorbent fibrous structure, of the present invention that comprises the soil adsorbing agent and the detackifier exhibits an Average Soil Adsorption (Soil Retention) Value of greater than 90 and/or greater than 100 and/or greater than 110 and/or greater than 125 and/or greater than 150 and/or greater than 175 and/or greater than 200 mg Soil/g of Fibrous Structure as measured according to the Soil Adsorption Test Method described herein before (initially) and after being subjected to the Accelerated and Stress Aging Procedures described herein.

In another example, the fibrous structure, for example absorbent fibrous structure, of the present invention that comprises the soil adsorbing agent and the detackifier exhibits an Average Mirror Cleaning Densitometer Value of greater than −0.5 and/or greater than −0.45 and/or greater than −0.38 and/or greater than −0.30 and/or greater than −0.25 and/or greater than −0.20 and/or greater than −0.15 as measured according to the Minor Cleaning Test Method described herein before (initially) and after being subjected to the Accelerated and Stress Aging Procedures described herein.

In still another example, the fibrous structure, for example absorbent fibrous structure, of the present invention that comprises the soil adsorbing agent and the detackifier exhibits a Probe Tack Sticky Energy Value of 750 or less and/or less than 750 and/or less than 600 and/or less than 400 and/or less than 200 and/or to about 0 and/or to about 50 mg*cm/cm² as measured according to the Probe Tack Test Method described herein.

In another example, the fibrous structure, for example absorbent fibrous structure, of the present invention that comprises the soil adsorbing agent and the detackifier may exhibit a combination of one or more properties, such as a Probe Tack Sticky Energy Value (750 or less and/or less than 750 and/or less than 600 and/or less than 400 and/or less than 200 and/or to about 0 and/or to about 50 mg*cm/cm²), an Average Mirror Cleaning Densitometer Value (greater than −0.5 and/or greater than −0.45 and/or greater than −0.38 and/or greater than −0.30 and/or greater than −0.25 and/or greater than −0.20 and/or greater than −0.15), and/or an Average Soil Adsorption Value (greater than 90 and/or greater than 100 and/or greater than 110 and/or greater than 125 and/or greater than 150 and/or greater than 175 and/or greater than 200 mg Soil/g of Fibrous Structure) as measured according to their respective test methods described herein.

It has been unexpectedly found that fibrous structures, for example absorbent fibrous structures, comprising a soil adsorbing agent, for example a copolymer, such as a branched copolymer, according to the present invention, and a detackifier, for example an inorganic and/or an organic detackifier, which may be in an emulsion with the soil adsorbing agent and a hydrocarbon fluid, exhibit a CRT Initial Rate of greater than 0.15 g/second and/or greater than 0.20 g/second and/or greater than 0.30 g/second and/or greater than 0.40 g/second as measured according to the CRT Test Method described herein. It has further unexpectedly been found that absorbent fibrous structures comprising a soil adsorbing agent of the present invention and a detackifier of the present invention exhibit a CRT Initial Rate Change of less than 50% and/or less than 40% and/or less than 30% and/or less than 20% and/or less than 15% and/or less than 10% and/or less than 5% as measured according to the CRT Test Method described herein.

The fibrous structure, for example absorbent fibrous structure, of the present invention may comprise a plurality of pulp fibers. Further, the fibrous structure, for example absorbent fibrous structure, of the present invention may comprise a single-ply or multi-ply sanitary tissue product, such as a paper towel.

In another example, the fibrous structure, for example the absorbent fibrous structure, may be in the form of a cleaning pad suitable for use with a cleaning device, such as a floor cleaning device, for example a Swiffer® cleaning pad or equivalent cleaning pads.

In one example, the soil adsorbing agent, for example a copolymer, such as a branched copolymer soil adsorbing agent, for example soil adsorbing branched copolymer particles, which may be present in an emulsion with the detackifier and a hydrocarbon fluid, may be present in and/or on a fibrous structure, for example absorbent fibrous structure, in a pattern, such as a non-random repeating pattern composing lines and or letters/words, and/or present in and/or on regions of different density, different basis weight, different elevation and/or different texture of the absorbent fibrous structure. Such patterning may be used to control deposition of the soil adsorbing agent and/or detackifier. In one example, the soil adsorbing agent, for example soil adsorbing agent, for example soil adsorbing agent polymer particles may be present in and/or on the fibrous structure, for example absorbent fibrous structure, in one pattern, such as a non-random repeating pattern, and the detackifier may be present in and/or on the fibrous structure, for example absorbent fibrous structure, in a second pattern, different from, but may be complementary to the pattern of the soil adsorbing agent. In one example, the soil adsorbing agent and/or detackifier present in and/or on a fibrous structure, for example an absorbent fibrous structure, may provide a visual signal, for example resulting from an increased concentration of soil adsorbed onto the soil adsorbing agent.

In one example, the detackifier, for example an inorganic detackifier and/or an organic detackifier, present in the emulsion with the soil adsorbing agent and/or in a separate emulsion and/or in a separate carrier, such as a hydrocarbon fluid, on the fibrous structure, absorbent fibrous structure, may be present on the fibrous structure in a pattern, such as a non-random repeating pattern composing lines and or letters/words, and/or present in and/or on regions of different density, different basis weight, different elevation and/or different texture of the absorbent fibrous structure.

In addition to the soil adsorbing agent and the detackifier, which may be present together in an emulsion and/or a carrier in the case of the detackifier, or separate and discrete, the fibrous structure, for example absorbent fibrous structure, and/or emulsions and/or carrier may comprise other ingredients, for example one or more surfactants. The surfactants may be present in and/or on the fibrous structure, for example absorbent fibrous structure, at a level of from about 0.01% to about 0.5% by weight of the fibrous structure. Non-limiting examples of suitable surfactants include C₈₋₁₆ alkyl polyglucoside, cocoamido propyl sulfobetaine, and mixtures thereof.

In one example, the fibrous structure comprises a signal, such as a dye and/or pigment, that becomes visible or becomes invisible to a consumer's eye when the absorbent fibrous structure adsorbs soil and/or when a soil adsorbing agent, for example soil adsorbing polymer particle, present in and/or on the fibrous structure adsorbs soil. In another example, the signal may be a difference in texture of the absorbent fibrous structure or a difference in the physical state of the fibrous structure, for example the absorbent fibrous structure dissolves and/or vaporizes when the absorbent fibrous structure adsorbs soil.

### Emulsion

The emulsion of the present invention comprises a continuous phase, for example a non-aqueous continuous phase such as a hydrocarbon fluid phase, for example an oil (for example white mineral oil) and/or ester (for example alkyl alkylates, such as octyl stearate) phase, and a dispersed phase (discontinuous phase) comprising one or more soil adsorbing agents, such as copolymer soil adsorbing agents, for example branched copolymer soil adsorbing agents, for example water-soluble soil adsorbing polymer particles, and one or more detackifiers, for example inorganic and/or organic detackifiers, which when present are present in the continuous phase, for example in the hydrocarbon fluid.

In one example, the emulsion of the present invention may comprise 50% or greater by weight of soil adsorbing agent, such as a copolymer soil adsorbing agent, for example branched copolymer soil adsorbing agent, 25% or less by weight of detackifier, for example an inorganic detackifier and/or organic detackifier, and 50% or less of a hydrocarbon fluid.

In another example, the emulsion of the present invention may be made by diluting an emulsion comprising 50% or greater by weight of soil adsorbing agent, such as a copolymer soil adsorbing agent, for example branched copolymer soil adsorbing agent, a detackifier, for example an inorganic detackifier and/or an organic detackifier, and a hydrocarbon fluid with additional hydrocarbon fluid, for example alkyl alkylate, to reduce the level of soil adsorbing agent, such as a copolymer soil adsorbing agent, for example branched copolymer soil adsorbing agent to less than 37% and/or less than 30% and/or greater than 10% and/or greater than 15% and/or greater than 20% by weight of the emulsion.

In addition to the soil adsorbing agent, the emulsion may comprise greater than 0.1% and/or greater than 0.5% and/or greater than 1% and/or greater than 2% and/or less than 25% and/or less than 20% and/or less than 15% and/or less than 10% and/or from about 0.1% to about 50% and/or from about 0.1% to about 45% and/or from about 0.1% to about 25% and/or from about 0.5% to about 10% and/or from about 0.5% to about 5% by weight of the emulsion of detackifier.

In another example, the emulsion and/or fibrous structure comprises a weight ratio of detackifier to soil adsorbing agent of greater than 0.01:1 and/or greater than 0.1:1 and/or greater than 0.2:1 and/or greater than 0.5:1 and/or less than 1.5:1 and/or less than 1.25:1 and/or less than 1.1:1 and/or from about 0.1:1 to about 1:1. In addition to the weight ratio of the components in the emulsion and/or on the fibrous structure, the ratio of particle count of detackifier to particle count of soil adsorbing polymer in the emulsion and/or on the fibrous structure may be greater than 1:20 and/or greater than 1:30 and/or greater than 1:50 and/or greater than 1:100 and/or greater than 1:500 and/or greater than 1:1000 and/or greater than 1:10,000 and/or less than 1:10,000,000 and/or less than 1:8,000,000 and/or less than 1:6,000,000 and/or from about 1:30 to about 1:6,000,000.

In one example, the emulsion is a dewatered emulsion.

In one example, the emulsion, for example the dewatered emulsion, comprises less than 7% and/or less than 5% and/or less than 3% and/or less than 1% to about 0% by weight of the emulsion of water. In another example, at least a portion of any water present in the dewatered emulsion is present in at least one of the particles of the dewatered emulsions of the present invention.

In one example, the neat emulsion may exhibit a bulk viscosity of less than 3000 cP and/or less than 2000 cP as measured according to the Bulk Viscosity Test Method described herein. In another example, the neat emulsion may exhibit a bulk viscosity of greater than 50 cP as measured according to the Bulk Viscosity Test Method described herein. In one example, the neat emulsion exhibits bulk viscosity of from about 100 cP to about 3000 cP and/or from about 250 cP to about 2500 cP and/or from about 250 cP to about 2000 cP and/or from about 300 cP to about 1500 cP as measured according to the Bulk Viscosity Test Method described herein.

In another example, the emulsion as a whole may exhibit a VOC content of less than 5.5% and/or less than 3% and/or less than 1% and/or less than 0.75% as measured according to the VOC Test Method, described herein.

In one example, the emulsion comprises less than 500 ppm and/or less than 350 ppm and/or less than 200 ppm and/or less than 150 ppm and/or less than 50 ppm and/or no detectable level of residual acrylamide monomer as measured according to the Acrylamide Monomer Test Method described herein.

In one example, the emulsion may comprise two or more soil adsorbing polymers. In another example, the dewatered emulsion may comprise a blend (mixture) of two or more soil adsorbing polymers at least one of which is a branched copolymer. In yet another example, the dewatered emulsion may comprise two or more different soil adsorbing polymers at least one of which is a copolymer, for example a branched copolymer. In one example, a soil adsorbing polymer (agent) that exhibits improved soil adsorption values and a different soil adsorbing polymer (agent) that exhibits improved mirror cleaning values may be combined into a single emulsion and/or be present on a fibrous structure, for example absorbent fibrous structure.

a. Hydrocarbon Fluid

In one example, the emulsion comprises a non-aqueous continuous phase comprising a hydrocarbon fluid. The hydrocarbon fluid may exhibit a VOC content of less than 60% and/or less than 50% and/or less than 40% and/or less than 30% and/or less than 20% and/or less than 10% and/or less than 5% and/or less than 1% as measured according to the VOC Test Method described herein.

In one example, the hydrocarbon fluid comprises an oil, such as a mineral oil, for example white mineral oil, lanolin oil, hydrogenated polyisobutene, synthetic isoparaffinic fluids, and/or a vegetable oil, for example high oleic sunflower seed oil. Non-limiting examples of suitable oils are selected from the group consisting of: paraffinic oils (such as liquid paraffin, mineral oil, for example white mineral oil (Protol® is a white mineral oil commercially available from Sonneborn Refined Products) and mixtures thereof), naphthenic oils (such as cycloalkanes of the general formula CₙH_{2(n+1-g)} wherein n is the number of carbon atoms, for example greater than 6 and/or greater than 8 and/or greater than 10, and g is the number of rings in the molecule, for example greater than 1 and/or greater than 2 and mixtures of such cycloalkanes).

In another example, the hydrocarbon fluid comprises an ester, such as an alkyl alkylate, for example a C₄-C₂₀ stearate, for example octyl stearate, and/or C₄-C₂₀ oleate, for example butyl oleate. Non-limiting examples of other suitable esters are selected from the group consisting of: synthetic ester oils prepared by the reaction of a carboxylic acid and an alcohol of the general formula CH₃(CH₂)ₓCO₂(CH₂)_{y}CH₃ wherein x and y are independently from 1 to about 20 and/or from about 6 to about 20; additionally the hydrocarbon chains may be saturated, mono-unsaturated and/or polyunsaturated and exist as a water insoluble oil at 23° C.±1.0° C. In one example, the hydrocarbon fluid comprises an alkyl alkylate ester, other natural and synthetic esters, mono-, di- and triesters of glycerol, mono-, and diesters of diols, for example ethylene glycol and propylene glycol, mono- and diesters of phthalic acid, fatty acid salt soaps of sodium and potassium, mono- and diesters of sulfoscuccinic acid, various diethanol amides made by reacting the fatty acids from vegetable oils, for example coconut oil and/or sunflower oil with diethanol amines, and mixtures thereof, selected from the group consisting of:

| | | |
|---|---|---|
| Butyl oleate | Glycerol monooleate | Octyl stearate |
| Butyl stearate | Glycerol monolaurate | (Oleic |
| Cetyl stearyl stearate | Glycerol monostearate | diethanolamide) |
| Coconut diethanolamide | Glycerol trioleate | Polyethylene |
| Di-2-ethyl hexyl phthalate | Isooctyl stearate | glycol oleate |
| Di-2-ethyl hexyl | Methyl castorate | Potassium cocoate |
| sulfosuccinate | Methyl cocoate | Potassium laurate |
| Dicetyl phthalate | Methyl laurate | Potassium oleate |
| Diethyl stearates | Methyl oleate | Propylene glycol |
| Ethyl castorate | Methyl ricinoleate | oleate |
| Ethyl cocoate | Methyl stearate | Stearyl stearate |
| Ethyl laurate | Methyl tallowate | Octyl palmitate |
| Ethyl oleate | Myristyl myristate | (Ethylhexyl |
| Ethyl ricinoleate | Isostearyl Stearoyl Stearate | stearate) |
| Ethyl stearate | Isostearyl Lactate | (Ethylhexyl |
| Ethylene glycol distearate | Triisocetyl Citrate | palmitate) |
| Cetyl Octanoate | C12-15 Alkyl Benzoate | (Diisopropyl |
| Isostearyl Isononanoate | (Octyldodecyl | Adipate Sebacate) |
| | Neopentanoate) | and mixtures |
| | | thereof. |

Non-limiting examples of other suitable hydrocarbon fluids are selected from the group consisting of: vegetable oil, for example triglycerides such as Safflower, Sunflower, Soybean, Canola, and Rapeseed oils, and mixtures thereof.

In one example, the hydrocarbon fluid is present in the emulsion at a level of at least 10% and/or at least 25% and/or at least 40% and/or to about 90% and/or to about 80% and/or to about 70% and/or to about 60% and/or to about 50% by weight of the emulsion.

In one example, the emulsion may comprise an oil, such as white mineral oil, and an ester, such as an alkyl alkylate, for example octyl stearate.

b. Inverting Surfactant

The emulsion may comprise an inverting surfactant. In one example, an inverting surfactant is present in the emulsion at a level of at least 6% and/or greater than 6% and/or at least 9% and/or at least 12% to about 30% and/or to about 20% and/or to about 15% by weight of the emulsion. In another example, the inverting surfactant is present in the emulsion at a level of from about 0 to about 15% and/or from about 5 to about 13% by weight of the emulsion. The upper limit of the inverting surfactant level is only linked to the stability of the emulsion, once the inverting surfactant is added. In one example, 1 to 7% by weight of the emulsion of the inverting surface is enough to get a proper inversion in aqueous systems.

The inverting surfactant may improve the polymer's (water-soluble polymer particle polymer) dissolution in water.

In one example, the inverting surfactant comprises a nonionic surfactant. In another example, the inverting surfactant exhibits an HLB of at least 10, and/or from about 10 to 20 and/or from about 10 to about 15 and/or from about 10 to about 14.

In another example, the inverting surfactant is selected from the group consisting of: fatty alcohol ethoxylates for example Plurafac LF400, alkyl polyglucosides, ethoxylated sorbitan esters, for instance ethoxylated sorbitan oleate with 20 mequivalents of ethylene oxide (EO 20), Castor oil ethoxylate (Alkamuls EL-620), 2) Tridecyl alcohol ethoxylate (Alkamuls BC-720), Propylene oxide/ethylene oxide copolymer (ICI RA-290), nonyl phenol ethoxylate (Alkasurf CO-630), and propylene oxide/ethylene oxide copolymer (ICI RA-280). Certain silicone compounds such as dimethicone copolyols may also be used as inverting surfactants.

In one example, a portion of the inverting surfactant present in the emulsion may be present in at least one of the water-soluble polymer particles present in the emulsion.

In another example, at least a portion and/or a majority and/or substantially all, if not all, of the inverting surfactant present in the emulsion is present in the continuous phase (hydrocarbon fluid) of the emulsion.

c. Emulsifying Surfactant

The emulsion may also comprise an emulsifying surfactant. In one example, an emulsifying surfactant is present in the emulsion at a level of at least 1% and/or at least 2% and/or at least 3% and/or at least 4% to about 20% and/or to about 10% and/or to about 6% by weight of the emulsion.

In one example, the emulsifying surfactant comprises a nonionic surfactant. In another example, the emulsifying surfactant exhibits an HLB of less than 10 and/or from about 3 to about 8.

In one example the emulsifying surfactant includes sorbitan monooleate and/or sorbitan isostearate. Non-limiting examples of other suitable emulsifying surfactants include those surfactants described U.S. Pat. No. 6,686,417, for example sorbitan fatty acid esters, such as the mono, sesqui, and/or tri-fatty acid esters, for example C₁₄ to C₂₀ mono-unsaturated fatty acid like oleic acid, esters and sorbitan mono-oleate; glycerol mono and/or di-fatty acid esters, for example C₁₄ to C₂₀ mono-unsaturated fatty acid, such as oleic acid, esters; and fatty acid alkanolamides, for example those ethanolamides, such as diethanolamides, for example those diethanolamides based on C₁₄ to C₂₀ mono-unsaturated fatty acids, such as oleic acid. The oleic acid in such compounds may be provided by mixed fatty acid feedstocks e.g. rape seed fatty acids, including C₁₄ to C₂₀ mono-unsaturated fatty acid, particularly oleic acid, as a main constituent. In one example, the emulsifying surfactants include those commercially available from ICI Surfactant under the trade name Span 80. Additional non-limiting examples of emulsifying surfactants include ethylene oxide propylene oxide block copolymers, alkylene (generally ethylene) oxide condensates of alkyl phenols or fatty alcohols, and polyalkylene (generally ethylene) glycol condensates of fatty acids. Suitable materials are ethylene oxide condensates of octyl phenol or nonyl phenol, ethylene oxide condensates of fatty alcohols such as blends of cetyl and oleyl alcohol or C9-11 alkyl alcohols, polyethylene glycol 200, 300 or 400 oleates of the isopropylamine salt of dodecyl benzene sulphonate.

In one example, the emulsifying surfactant is associated with, for example present in and/or present on, the water-soluble soil adsorbing polymer particle to keep the water-soluble polymer particle dispersed within the continuous phase, for example the hydrocarbon fluid within the emulsion of the present invention.

In one example, at least a portion and/or a majority and/or substantially all, if not all, of the emulsifying surfactant present in the emulsion is present in and/or on at least one of the water-soluble soil adsorbing polymer particles within the emulsion.

In another example, a portion of the emulsifying surfactant present in the emulsion may be present in the continuous phase (hydrocarbon fluid) of the emulsion.

d. Water-Soluble Polymer Particles

One or more water-soluble polymer particles, such as water-soluble soil adsorbing polymers, for example branched copolymer water-soluble soil adsorbing polymer particles, may be dispersed within the continuous phase (hydrocarbon fluid) of the emulsion.

In one example, the water-soluble polymer particles are present in the emulsion at a level of greater than 10% and/or greater than 15% and/or greater than 20% and/or greater than 30% and/or greater than 50% by weight of the emulsion.

In one example, the water-soluble polymer particles, for example water-soluble soil adsorbing branched copolymer particles, are in and/or on the absorbent fibrous structure at a level of greater than 0.005% and/or greater than 0.0075% and/or greater than 0.01% and/or greater than 0.05% and/or greater than 0.1% and/or greater than 0.15% and/or greater than 0.2% and/or less than 5% and/or less than 3% and/or less than 2% and/or less than 1% by weight of the absorbent fibrous structure. In one example, the water-soluble polymer particle is present in and/or on the absorbent fibrous structure at a level of from about 0.005% to about 1% by weight of the absorbent fibrous structure.

In another example of the present invention, the fibrous structure, for example absorbent fibrous structure, may comprise the water-soluble polymer particles, for example water-soluble soil adsorbing branched copolymer particles, at a level of from greater than 0 pounds/ton (#/ton) and/or greater than 0.1 #/ton and/or greater than 0.5 #/ton and/or greater than 1 #/ton and/or greater than 2 #/ton and/or greater than 3 #/ton and/or to less than 20 #/ton and/or to less than 15 #/ton and/or to less than 10 #/ton and/or to less than 6 #/ton and/or to 5 #/ton or less and/or to 4 #/ton or less by weight of the fibrous structure.

The level of water-soluble polymer particles, such as water-soluble soil adsorbing branched copolymer particles, present in and/or on an absorbent fibrous structure as used herein according to the present invention is in terms of active solids basis of the soil adsorbing polymer.

In one example, the water-soluble polymer particles, when present on an absorbent fibrous structure of the present invention, are non-aqueous and/or dry and/or void of water (for example less than 10% and/or less than 7% and/or less than 5% and/or less than 3% to 0 or about 0% by weight of the water-soluble polymer particle). This clearly distinguishes the water-soluble polymer particles from latex, which is an aqueous emulsion of polymers.

One or more of the water-soluble polymer particles of the present invention comprises a water-soluble soil adsorbing branched copolymer. Without wishing to be bound by theory, it is believed that the water-soluble polymer, for example the water-soluble soil adsorbing branched copolymer, present on an absorbent fibrous structure of the present invention is in a coiled configuration until exposed to excess polar solvent, for example water, at which time it uncoils to an extended functional form to provide its benefits, for example soil adsorbing benefits.

In one example, the water-soluble polymer particle, for example water-soluble soil adsorbing branched copolymer particle, comprises the water-soluble soil adsorbing branched copolymer, and an emulsifying surfactant.

In one example, the water-soluble polymer particle exhibits an average particle size of from about 500 nm to about 50 μm and/or from about 700 nm to about 25 μm and/or from about 800 nm to about 10 μm and/or from about 800 nm to about 5 μm and/or from about 800 nm to about 1 μm.

In one example, the copolymer soil adsorbing agent, for example branched copolymer soil adsorbing agent exhibits a weight average molecular weight of greater than 750,000 and/or greater than 1,500,000 and/or greater than 4,000,000 and/or to about 40,000,000 and/or to about 20,000,000 and/or to about 10,000,000 g/mol based on the Gel Permeation Chromatography method.

In another example, the copolymer soil adsorbing agent, for example the branched copolymer soil adsorbing agent exhibits a number average molecular weight of greater than 200,000 g/mol and/or greater than 500,000 g/mol and/or greater than 750,000 g/mol and/or greater than 900,000 g/mol to less than 2,000,000 g/mol and/or less than 1,750,000 g/mol and/or less than 1,500,000 g/mol based on the Gel Permeation Chromatography method. In one example, the soil adsorbing agent exhibits a number average molecular weight of from about 500,000 g/mol to about 2,000,000 g/mol and/or from about 900,000 g/mol to about 1,700,000 g/mol based on the Gel Permeation Chromatography method.

Non-limiting examples of suitable chemicals include polymers, including but not limited to copolymers, for example branched copolymers. In one example, the copolymer soil adsorbing agent, for example the branched copolymer soil adsorbing agent comprises a copolymer, for example a branched copolymer comprising monomeric units derived from acrylic acid and/or quaternary ammonium compounds and/or acrylamide.

In one example, the copolymer soil adsorbing agent, for example the branched copolymer soil adsorbing agent may be used as a highly concentrated inverse emulsion (for example a water-in-oil emulsion), containing greater than 10% and/or greater than 15% and/or greater than 20% and/or greater than 25% and/or greater than 30% and/or greater than 35% and/or to about 60% and/or to about 55% and/or to about 50% and/or to about 45% active. The oil (hydrocarbon fluid) phase may consist of high quality mineral oil, such as white mineral oil, and/or an alkyl alkylate, such as octyl stearate. In another example the soil adsorbing agents may be used as a highly concentrated dewatered emulsion for example dry particles suspended in a continuous hydrocarbon phase, containing greater than 10% and/or greater than 15% and/or greater than 20% and/or greater than 25% and/or greater than 30% and/or greater than 35% and/or to about 60% and/or to about 55% and/or to about 50% and/or to about 45% active. In one example, the oil phase may consist of high quality mineral oil with boiling point range of 468-529° F. or a heavy mineral oil with boiling point range of 608-968° F. In one example, the soil adsorbing agent may be used as a highly concentrated inverse emulsion wherein the continuous phase of the inverse emulsion comprises mineral oil, such as white mineral oil.

The emulsions, for example inverse emulsions, such as dewatered inverse emulsions, of the present invention may be directly applied to a surface of an absorbent fibrous structure, a surface of a wet absorbent fibrous structure and/or added to the wet-end of a papermaking process.

The soil adsorbing agent, such as the copolymer soil adsorbing agents, for example the branched copolymer soil adsorbing agents may be anionic, neutral and/or cationic under pH 4.5 conditions. In one example, the soil adsorbing agents, such as the copolymer soil adsorbing agents, for example the branched copolymer soil adsorbing agent comprises a quaternary ammonium compound under pH 4.5 conditions. In another example, the soil adsorbing agent, such as the copolymer soil adsorbing agents, for example the branched copolymer soil adsorbing agent comprises an amine under pH 4.5 conditions. In still another example, the copolymer soil adsorbing agents, for example the branched copolymer soil adsorbing agent comprises an acrylamide under pH 4.5 conditions.

The soil adsorbing agent may comprise a copolymer, for example a branched copolymer comprising one or more monomeric units derived from quaternary ammonium compounds, amine compounds, acrylamide compounds, acrylic acid compounds and mixtures thereof at various weight ratios within the polymer.

In one example, the soil adsorbing agent is a copolymer of acrylamide and one or more other nonionic monomers, for example non-acrylamide monomers, such as hydroxyalkylacrylate, for example hydroxypropylacrylate,

In one example, the soil adsorbing agent is a branched copolymer of acrylamide and bismethyleneacrylamide, a crosslinking agent, that converts a typical linear polyacrylamide into a branched structure. The bismethyleneacrylamide may be present in the branched copolymer at a level of less than 200 ppm and/or less than 100 ppm and/or less than 50 ppm and/or greater than 1 ppm and/or greater than 2 ppm and/or greater than 10 ppm and/or greater than 20 ppm. In one example, the bismethyleneacrylamide may be present in the branched copolymer at a level of from about 2.5 ppm to about 25 ppm.

In another example, the soil adsorbing agent is a copolymer of acrylamide and hydroxyalkylacrylate, such as hydroxypropylacrylate. The hydroxyalkylacrylate may be present in the copolymer at a level of less than 50% and/or less than 40% and/or less than 30% and/or less than 20% and/or less than 10% and/or less than 5% and/or greater than 0.01% and/or greater than 0.1% and/or greater than 0.5%. In one example, the hydroxyalkylacrylate may be present in the copolymer at a level of from about 1% to about 3%.

The soil adsorbing agent, such as the copolymer soil adsorbing agent, for example branched copolymer soil adsorbing agent, of the present invention may be present in one or more water-soluble polymer particles of the present invention.

The soil adsorbing agent of the present invention may comprise a nonionic monomeric unit, such as a nonionic monomeric unit derived from an acrylamide compound. Non-limiting examples of suitable nonionic monomeric units include nonionic monomeric units derived from nonionic monomers selected from the group consisting of: hydroxyalkyl esters of α,β-ethylenically unsaturated acids, such as hydroxyethyl or hydroxypropyl acrylates and methacrylates, glyceryl monomethacrylate, αβ-ethylenically unsaturated amides such as acrylamide, N,N-dimethylmethacrylamide, N-methylolacrylamide, αβ-ethylenically unsaturated monomers bearing a water-soluble polyoxyalkylene segment of the poly(ethylene oxide) type, such as poly(ethylene oxide) α-methacrylates (Bisomer S20W, S10W, etc., from Laporte) or α,ω-dimethacrylates, Sipomer BEM from Rhodia (ω-behenyl polyoxyethylene methacrylate), Sipomer SEM-25 from Rhodia (ω-tristyrylphenyl polyoxyethylene methacrylate), α,β-ethylenically unsaturated monomers which are precursors of hydrophilic units or segments, such as vinyl acetate, which, once polymerized, can be hydrolyzed in order to give rise to vinyl alcohol units or polyvinyl alcohol segments, vinylpyrrolidones, α,β-ethylenically unsaturated monomers of the ureido type, and in particular 2-imidazolidinone-ethyl methacrylamide (Sipomer WAM II from Rhodia). Other nonionic monomeric units suitable for the present invention include nonionic monomeric units derived from nonionic monomers selected from the group consisting of: vinylaromatic monomers such as styrene, alpha-methylstyrene, vinyltoluene, vinyl halides or vinylidene halides, such as vinyl chloride, vinylidene chloride, C₁-C₁₂ alkylesters of α,β-monoethylenically unsaturated acids such as methyl, ethyl or butyl acrylates and methacrylates, 2-ethylhexyl acrylate, vinyl esters or allyl esters of saturated carboxylic acids, such as vinyl or allyl acetates, propionates, versatates, stearates, α,β-monoethylenically unsaturated nitriles containing from 3 to 12 carbon atoms, such as acrylonitrile, methacrylonitrile, α-olefins such as ethylene, conjugated dienes, such as butadiene, isoprene, chloroprene. In one example, the soil adsorbing agent is a homopolymer, for example polyacrylamide.

The soil adsorbing agent of the present invention may comprise an anionic monomeric unit, such as an anionic monomeric unit derived from acrylic acid. Non-limiting examples of anionic monomeric units suitable for the present invention include anionic monomeric units derived from anionic monomers selected from the group consisting of: monomers having at least one carboxylic function, for instance α,β-ethylenically unsaturated carboxylic acids or the corresponding anhydrides, such as acrylic, methacrylic or maleic acids or anhydrides, fumaric acid, itaconic acid, N-methacroylalanine, N-acryloylglycine, and their water-soluble salts, monomers that are precursors of carboxylate functions, such as tert-butyl acrylate, which, after polymerization, give rise to carboxylic functions by hydrolysis, monomers having at least one sulfate or sulfonate function, such as 2-sulfooxyethyl methacrylate, vinylbenzene sulfonic acid, allyl sulfonic acid, 2-acrylamido-2-methylpropane sulfonic acid (AMPS), sulfoethyl acrylate or methacrylate, sulfopropyl acrylate or methacrylate, and their water-soluble salts, monomers having at least one phosphonate or phosphate function, such as vinylphosphonic acid, etc., the esters of ethylenically unsaturated phosphates, such as the phosphates derived from hydroxyethyl methacrylate (Empicryl 6835 from Rhodia) and those derived from polyoxyalkylene methacrylates, and their water-soluble salts, and 2-carboxyethyl acrylate (CEA). In one example, the soil adsorbing agent comprises a nonionic monomeric unit derived from an acrylamide compound and an anionic monomeric unit derived from acrylic acid.

The soil adsorbing agent of the present invention may comprise a cationic monomeric unit, such as a cationic monomeric unit derived from cationic monomers selected from the group consisting of: N,N-(dialkylamino-ω-alkyl)amides of α,β-monoethylenically unsaturated carboxylic acids, such as N,N-dimethylaminomethylacrylamide or -methacrylamide, 2-(N,N-dimethylamino)ethylacrylamide or -methacrylamide, 3-(N,N-dimethylamino)propylacrylamide or -methacrylamide, and 4-(N,N-dimethylamino)butylacrylamide or -methacrylamide, α,β-monoethylenically unsaturated amino esters such as 2-(dimethylamino)ethyl acrylate (DMAA), 2-(dimethylamino)ethyl methacrylate (DMAM), 3-(dimethylamino)propyl methacrylate, 2-(tert-butylamino)ethyl methacrylate, 2-(dipentylamino)ethyl methacrylate, and 2(diethylamino)ethyl methacrylate, vinylpyridines, vinylamine, vinylimidazolines, monomers that are precursors of amine functions such as N-vinylformamide, N-vinylacetamide, which give rise to primary amine functions by simple acid or base hydrolysis, acryloyl- or acryloyloxyammonium monomers such as trimethylammonium propyl methacrylate chloride, trimethylammonium ethylacrylamide or -methacrylamide chloride or bromide, trimethylammonium butylacrylamide or -methacrylamide methyl sulfate, trimethylammonium propylmethacrylamide methyl sulfate, (3-methacrylamidopropyl)trimethylammonium chloride (MAPTAC), (3-methacrylamidopropyl)trimethylammonium methyl sulphate (MAPTA-MES), (3-acrylamidopropyl)trimethylammonium chloride (APTAC), methacryloyloxyethyl-trimethylammonium chloride or methyl sulfate, and acryloyloxyethyltrimethylammonium chloride; 1-ethyl-2-vinylpyridinium or 1-ethyl-4-vinylpyridinium bromide, chloride or methyl sulfate; N,N-dialkyldiallylamine monomers such as N,N-dimethyldiallylammonium chloride (DADMAC); polyquaternary monomers such as dimethylaminopropylmethacrylamide chloride and N-(3-chloro-2-hydroxypropyl)trimethylammonium (DIQUAT) and 2-hydroxy-N¹-(3-(2((3-methacrylamidopropyl)dimethylammino)-acetamido)propyl)-N¹, N¹, N³, N³, N³-pentamethylpropane-1,3-diaminium chloride (TRIQUAT), and. In one example, the cationic monomeric unit comprises a quaternary ammonium monomeric unit, for example a monoquaternary ammonium monomeric unit, a diquaternary ammonium monomeric unit and a triquaternary monomeric unit. In one example, the cationic monomeric unit is derived from MAPTAC. In another example, the cationic monomeric unit is derived from DADMAC. In still another example, the cationic monomeric unit is derived from 2-hydroxy-N¹-(3-(2((3-methacrylamidopropyl)dimethylammino)-acetamido)propyl)-N¹, N¹, N³, N³, N³-pentamethylpropane-1,3-diaminium chloride.

e. Detackifiers

One or more detackifiers, for example inorganic detackifiers and/or organic detackifiers may be dispersed within the continuous phase (hydrocarbon fluid) of the emulsion. In one example, the detackifier comprises a metal stearate, for example a metal stearate selected from the group consisting of: aluminum stearate, zinc stearate, calcium stearate, magnesium stearate, and mixtures thereof. The detackifier may comprise talc, bentonite, stearalkonium bentonite, distearalkonium bentonite, metal stearates, metal salts of fatty acids, and mixtures thereof. Further, the detackifier may comprise cationic surfactants, silicone oils, polyethylene glycol di-stearates, ethylene glycol di-stearates, polyethylene glycol-modified fatty acids, ethylene glycol-modified fatty acids, and mixtures thereof.

In one example, the detackifiers are present in the emulsion at a level of greater than 0% and/or greater than 0.1% and/or greater than 1% and/or greater than 2% and/or less than 10% and/or less than 7% and/or less than 5% by weight of the emulsion.

In one example, the fibrous structure, for example absorbent fibrous structure, of the present invention comprises detackifier at a level of from greater than 0 pounds/ton (#/ton) and/or 0.01 #/ton or greater and/or 0.02 #/ton or greater and/or 0.03 #/ton or greater and/or 0.05 #/ton or greater and/or 0.09 #/ton or greater and/or 0.1 #/ton and/or greater than 0.5 #/ton and/or greater than 1 #/ton and/or greater than 2 #/ton and/or greater than 3 #/ton and/or to less than 20 #/ton and/or to less than 15 #/ton and/or to less than 10 #/ton and/or to less than 6 #/ton and/or to 5 #/ton or less and/or to 4 #/ton or less by weight of the fibrous structure.

In one example, the fibrous structure, for example absorbent fibrous structure, of the present invention comprises detackifier at a level of from about 0.5 pounds/ton (#/ton) to about The absorbent fibrous structure according to claim 1 wherein the detackifier is present on the 500 #/ton of the soil adsorbing agent.

Non-limiting examples of suitable inorganic detackifiers and organic metallic salts include minerals, such as talc, boron nitride, mica and clays where clay mineral examples include kaolin clays and/or smectite clays, such as bentonite clays (commercially available under the trade name Bentolite), for example stearalkonium bentonite and/or distearalkonium bentonite, hectorite clays and magnesium aluminum silicates, organoclays where mineral based clays have been treated with quaternary ammonium salt compounds, such as stearalkonium hectorite and disteardimonium bentonite, metal salts of carboxylic acids such as fatty acid based carboxylic acid, for example stearic acid and/or palmitic acid where the metal is sodium, potassium, calcium, magnesium, zinc, aluminum or mixtures thereof, for example zinc distearate and zinc dipalmitate, calcium distearate and calcium dibehenate, magnesium distearate, magnesium dimyristate, and magnesium dicetearate, aluminum mono-, di-, and tri- fatty acids, such as aluminum monostearate, aluminum distearate, aluminum tristearate, aluminum dihydroxy monostearate, and aluminum monopalmitate distearate, other monovalent metal salts of fatty acids, for example sodium stearate and potassium palmitate, and mixtures thereof.

Non-limiting examples of suitable organic detackifiers include fatty alcohols, for example stearyl alcohol, cetyl alcohol, behenyl alcohol and mixtures thereof, fatty acids, for example caproic acid, myristic acid, palmitic acid, oleic acid, stearic acid, coconut acid, behenic acid and mixtures thereof, mono-, di- and triesters of fruit acids, for example, esters of citric acid with an example being tristearyl citrate, tripalmityl citrate, monostearyl citrate, dibehenyl citrate and mixtures thereof, mono- and diesters of malic acid, for example distearyl malate or monopalmityl malate and mixtures thereof, mono- and diesters of maleic acid, for example dilauryl maleate, monostearyl maleate, dimyristyl maleate and mixtures thereof, mono- and diesters of tartaric acid like dipalmityl tartrate or palmitylstearyl tartrate or monostearyl tartrate and mixtures thereof, mono- and diesters of dicarboxylic acids, for example dipalmityl oxalate, or distearyl succinate or stearylbehenyl adipate and mixtures thereof, mono-, di- and triesters of glycerol such as glycerol tristearate, glycerol dipalmite, glycerol tripalmitate, glycerol tribehenate and mixtures thereof, triglycerides, for example caprylic/capric triglyceride, olus oil, triheptanoin, tricaprylin, hydrogenated coco-glycerides, hydrogenated palm oil, sunflower seed oil, coconut oil, and mixtures thereof, the mono- and diesters of diols such as ethylene glycol distearate, propanediol dicaprylate/caprate, butylene glycol dimyristate or butylene glycol dibehenate, or hexylene glycol dipalmitate or mixtures thereof, the mono-, di-, tri- and tetraesters of pentaerythritol such as pentaerythritol tetrastearate, pentaerythritol tetrapalmitate, pentaerythritol tristearate, pentaerythritol tribehenate, and mixtures thereof, acid amides like stearamide, oleamide, N,N-distearylstearmaide, N-monopalmitylstearamide, ethylene bis(stearamide), phosphoamides, sulfonamides and mixtures thereof, the mono-, di- and triesters of phosphoric acid such as the acid form of monocetyl phosphoric acid ester, the acid form of distearyl phosphoric acid ester, tribehenyl phosphate, and mixtures thereof, waxes, such as paraffin wax, microcrystalline wax, lanolin wax, polyethylene wax, other natural and synthetic waxes, such as beeswax, ceresine wax, carnauba wax and mixtures thereof, starches and modified starches, such as hydrophobically modified starch, for example tapioca starch modified with polymethylsilsesquioxane, cationic surfactants, for example quaternary ammonium salts diquaternary salts, ethoxylated quaternary salts and mixtures thereof, for example dicocoalkyldimethyl ammonium chloride or distearyldimethylammonium chloride, polydimethylsiloxane fluids with vicoscities in the range of 20 to 10,000 cSt, modified polydimethylsiloxanes, such as cetyl dimethicone, stearyl dimethicone, C₃₀₋₄₅ alkyl dimethicone, amino-modified silicones, quaternized silicones, epoxy functional silicones, and mixtures thereof, for example 10% by weight of stearyl dimethicone dissolved in 90% polydimethylsiloxane fluid with the polydimethylsiloxane fluid having a viscosity of 200 cSt, siloxane particles, such as polymethylsilsesquioxane where Tospearl microspheres from Momemtive Incorporated is an example, the mono- and diesters of polyethylene glycol like PEG-150 distearates and PEG-20 dibehenate and mixtures thereof, alkoxylated fatty acids, such as polyoxyethylene (20) stearate, PEG-100 stearate and mixtures thereof.

A blend of different detackifiers, for example inorganic and organic and silicone based detackifiers, different inorganic detackifiers, different organic detackifiers, and even different weight average molecular weights of detackifers, for example different weight average molecular weights of the same detackifer, such as the same inorganic detackifier and/or same organic detackifier, and/or different weight average molecular weights of different detackifiers, such as different inorganic detackifiers and/or different organic detackifiers and/or an inorganic and an organic detackifier, and mixtures thereof. In one example, the detackifier present in the emulsion and/or on a surface of the fibrous structure of the present invention is a blend of a high weight average molecular weight detackifier and a lower weight average molecular weight detackifier.

In one example, the detackifier comprises PROtack™ from Ductmate Industries, Inc. The emulsion comprises less than 500 #/ton (“lbs/ton”) and/or less than 400 #/ton and/or less than 300 #/ton and/or less than 200 #/ton and/or less than 100 #/ton and/or greater than or equal to 0.5 #/ton and/or greater than 1 #/ton and/or greater than 5 #/ton of a PROtack™ detackifier.

The Fibrous Structure

f. Optional Additives.

Optional additives may be added to the emulsion of the present invention. For example, sodium bisulfite may be added to the emulsion after completion of polymerization of the water-soluble polymer particle, for example water-soluble soil adsorbing polymer particle, to aid in the reduction of residual acrylamide monomer that may be present in the neat emulsion. One can also utilize anionic dispersants, for example a carboxylic acid, to aid in maintaining stability of the emulsion, for example the emulsion.

In one example, the soil adsorbing agent exhibits a charge density of less than 10 meq/g as measured according to the Charge Density Test Method, described herein. In another example, the soil adsorbing polymer exhibits a net charge density of greater than −5 meq/g to less than 5 meq/g as measured according to the Charge Density Test Method, described herein.

In one example, the soil adsorbing agent of the present invention exhibits a UL Viscosity of from about 1 to about 6 cP as measured according to the UL Viscosity Test Method described herein.

The soil adsorbing agent may be present in the emulsion at a level of greater than 10% and/or greater than 25% and/or greater than 30% and/or greater than 40% and/or greater than 50% and/or to about 90% and/or to about 75% and/or to about 65% by weight of the emulsion. In one example, the soil adsorbing polymer is present in the emulsion at a level of from about 30% to about 75% and/or from about 40% to 65% by weight of the emulsion.

In one example, the soil adsorbing agent is present in and/or on the absorbent fibrous structure at a level of greater than 0.005% by weight of the absorbent fibrous structure. In another example, the soil adsorbing agent is present in the absorbent fibrous structure at a level of from about 0.005% to about 5% and/or from about 0.005% to about 3% by weight of the absorbent fibrous structure.

### Process for Making Emulsion

The emulsions of the present invention may be made by any suitable process known in the art. A non-limiting example of a suitable process follows.

First, an inverse emulsion is prepared by dispersing a non-continuous phase (discontinuous phase), such as an aqueous phase, in a continuous phase, such as a non-aqueous continuous phase, for example a hydrocarbon fluid phase, such as an oil phase and/or an ester phase as follows. The aqueous phase is prepared by mixing one or more water-soluble, ethylenically unsaturated addition polymerizable monomers such as acrylamide and/or acrylic acid, and optionally, a water-soluble salt, such as alkali salts such as sodium chloride, sodium bromide, lithium chloride, lithium bromide, in water. When present, the water-soluble salt may be present in the dewatered emulsion at a level of from about 0% to about 4% and/or from about 0.05% to about 2% by weight of the dewatered emulsion. The hydrocarbon fluid phase is prepared by mixing an emulsifying surfactant and an inverting surfactant in a hydrocarbon fluid, such as an oil, for example white mineral oil, that exhibits a VOC content of less than 60% as measured according to the VOC Test Method described herein.

Next, a chemical free radical initiator is added to either the aqueous phase or the oil phase depending upon the solubility characteristics of the initiator.

The aqueous phase (discontinuous phase) is then dispersed into the hydrocarbon fluid phase (continuous phase). The water-soluble monomers are then polymerized within the aqueous phase thus resulting in an inverse emulsion comprising a water-soluble polymer, for example a water-soluble soil adsorbing polymer.

In one example, one or more detackifiers of the present invention may be added to the hydrocarbon fluid phase (continuous phase) before and/or after dispersion of the aqueous phase (discontinuous phase).

In one example, the one or more detackifiers are added to the inverse emulsion. In one example, one or more detackifiers are added to a separate hydrocarbon fluid phase (continuous phase), for example by pre-mixing, with high shear, the detackifiers with the hydrocarbon fluid before adding the resulting detackifier/hydrocarbon fluid into the inverse emulsion.

The inverse emulsion (water-in-oil emulsion) may then be dehydrated, for example by azeotropic distillation, to produce a dewatered emulsion (dewatered inverse emulsion) of the present invention comprising a plurality of water-soluble polymer particles dispersed throughout the oil (hydrocarbon fluid) continuous phase.

### Process for Making Fibrous Structure

A fibrous structure suitable for use in the present invention may be made by any suitable process known in the art.

An example of a process for making a fibrous structure, for example absorbent fibrous structure, of the present invention comprising an emulsion comprising a soil adsorbing agent, for example a water-soluble soil adsorbing polymer particle, a detackifier, and a hydrocarbon fluid, the fibrous structure is contacted with the emulsion of the present invention.

In another example, a process for making an absorbent fibrous structure, such as a wet-laid fibrous structure, comprising an emulsion comprising a soil adsorbing agent, a detackifier, and a hydrocarbon fluid comprises the steps of:
a. providing a fiber slurry;
b. depositing the fiber slurry onto a foraminous wire to form an embryonic web;
c. drying the embryonic web, for example at least partially on a patterned belt, to produce a fibrous structure; and
d. contacting the fibrous structure with the emulsion to produce a fibrous structure, for example an absorbent fibrous structure, for example a dry absorbent fibrous structure, comprising the emulsion.

In yet another example, a process for making a fibrous structure, for example an absorbent fibrous structure, such as a wet-laid absorbent fibrous structure, comprises the steps of:
a. providing a fiber slurry;
b. adding an emulsion comprising a soil adsorbing agent, for example a branched copolymer soil adsorbing agent, for example a water-soluble soil adsorbing polymer to the fiber slurry after the emulsion is inverted into an aqueous emulsion (for example by utilizing procedures as outlined by the supplier of the emulsion);
c. depositing the fiber slurry onto a foraminous wire to form an embryonic web; and
d. drying the embryonic web, for example at least partially on a patterned belt; and
e. contacting the fibrous structure with an emulsion comprising a soil adsorbing agent, a detackifier, and a hydrocarbon fluid, to produce a fibrous structure, for example an absorbent fibrous structure, for example a dry absorbent fibrous structure, comprising the emulsion.

The fiber slurries and/or fibrous structures, for example absorbent fibrous structures, may comprise permanent and/or temporary wet strength agents such as Kymene® (permanent wet strength) and Hercobond® (temporary wet strength) both available from Ashland Inc. and/or Parez® (wet strength chemistries) available from Kemira Chemicals, Inc.

The fiber slurries and/or fibrous structures, for example absorbent fibrous structures, may comprise dry strength agents such as carboxymethylcellulose, starch, polyvinylamides, polyethyleneimines, melamine/formaldehyde, epoxide, and mixtures thereof.

In still yet another example, a process for making a fibrous structure, for example an absorbent fibrous structure, such as an air-laid absorbent fibrous structure, comprises the steps of:
a. providing pulp fibers;
b. producing an air-laid fibrous structure from the pulp fibers; and
c. optionally applying a binder, for example a latex binder, to a surface of the air-laid fibrous structure; and
d. contacting the air-laid fibrous structure with an emulsion comprising a soil adsorbing agent, a detackifier, and a hydrocarbon fluid to produce a fibrous structure, for example an absorbent fibrous structure, comprising the emulsion.

In one example, the emulsion of the present invention may be added to a fibrous structure, for example an absorbent fibrous structure, during papermaking, between the Yankee dryer and the reel, and/or during converting by applying it to one or more surfaces of the fibrous structure. In one example, a single-ply paper towel comprising a fibrous structure of the present invention comprises the emulsion of the present invention on one surface of the paper towel. In another example, a single-ply paper towel comprising a fibrous structure of the present invention comprises the emulsion of the present invention on both surfaces of the paper towel. In still another example, a two-ply paper towel comprising one or more fibrous structures of the present invention comprises the emulsion of the present invention on one or both exterior surfaces of the two-ply paper towel. In still another example, a two-ply paper towel comprising one or more fibrous structures of the present invention comprises the emulsion of the present invention on one or more interior surfaces of the two-ply paper towel. In yet another example, a two-ply paper towel comprising one or more fibrous structures of the present invention comprises the emulsion of the present invention on one or more exterior surfaces and one or more interior surfaces of the two-ply paper towel. One of ordinary skill would understand that one or more exterior surfaces and one or more interior surfaces of a three or more ply paper towel comprising one or more fibrous structures of the present invention could comprise the emulsion of the present invention.

In another example, the fibrous structure, for example absorbent fibrous structure, comprising an emulsion of the present invention may be made by printing an emulsion onto a surface of the fibrous structure, for example in a converting operation. The printing operation may occur by any suitable printing equipment, for example by way of a gravure roll and/or by a permeable fluid applicator roll. In still another example, a fibrous structure, for example an absorbent fibrous structure, comprising an emulsion of the present invention may be made by extruding an emulsion onto a surface of the fibrous structure.

In even another example, a fibrous structure, for example an absorbent fibrous structure, comprising an emulsion of the present invention may be made by spraying an emulsion onto a surface of the fibrous structure. In yet another example, a fibrous structure, for example an absorbent fibrous structure, comprising an emulsion of the present invention may be made by spraying an emulsion onto a wet fibrous structure during papermaking after the vacuum dewatering step, but before the pre-dryers and/or after the pre-dryers, but before the Yankee. In another example, the emulsion comprising the soil adsorbing agent and detackifier may be applied to a fibrous structure via a permeable roll applicator.

In even yet another example, a fibrous structure, for example an absorbent fibrous structure, comprising an emulsion of the present invention may be made by depositing a plurality of fibers mixed with an emulsion of the present invention in an air-laid and/or coform process.

In still another example, a fibrous structure, for example an absorbent fibrous structure, comprising an emulsion of the present invention may be made by adding one or more emulsions of the present invention at acceptable locations within spunbonding, meltblowing, dry spinning, carding, and/or hydroentangling processes used to make the fibrous structure.

### NON-LIMITING EXAMPLES

Examples of fibrous structures, for example absorbent fibrous structures; namely, paper towels for use in the comparative and inventive examples below are produced utilizing a cellulosic pulp fiber furnish consisting of about 55% refined softwood furnish consisting of about 44% Northern Bleached Softwood Kraft (Bowater), 44% Northern Bleached Softwood Kraft (Celgar) and 12% Southern Bleached Softwood Kraft (Alabama River Softwood, Weyerhaeuser); about 30% of unrefined hardwood Eucalyptus Bleached Kraft consisting of about 80% (Fibria) and 20% NBHK (Aspen) (Peace River); and about 15% of an unrefined furnish consisting of a blend of about 27% Northern Bleached Softwood Kraft (Bowater), 27% Northern Bleached Softwood Kraft (Celgar), 42% Eucalyptus Bleached Kraft (Fibria) and 4% Southern Bleached Kraft (Alabama River Softwood, Weyerhaeuser). The 55% refined softwood is refined as needed to maintain target wet burst at the reel. Any furnish preparation and refining methodology common to the papermaking industry can be utilized.

A 3% active solution Kymene 5221 is added to the refined softwood line prior to an inline static mixer and 1% active solution of Wickit 1285, an ethoxylated fatty alcohol available from Ashland Inc. is added to the unrefined Eucalyptus Bleached Kraft (Fibria) hardwood furnish. The addition levels are 21 and 1 lbs active/ton of paper, respectively.

The refined softwood and unrefined hardwood and unrefined NBSK/SSK/Eucalyptus bleached kraft/NDHK thick stocks are then blended into a single thick stock line followed by addition of 1% active carboxymethylcellulose (CMC- Finnfix) solution at 7 lbs active/ton of paper towel, and optionally, a softening agent may be added.

The thick stock is then diluted with white water at the inlet of a fan pump to a consistency of about 0.15% based on total weight of softwood, hardwood and simulated broke fiber. The diluted fiber slurry is directed to a non layered configuration headbox such that the wet web formed onto a Fourdrinier wire (foraminous wire). Optionally, a fines retention/drainage aid may be added to the outlet of the fan pump.

Dewatering occurs through the Fourdrinier wire and is assisted by deflector and vacuum boxes. The Fourdrinier wire is of a 5-shed, satin weave configuration having 87 machine-direction and 76 cross-direction monofilaments per inch, respectively. The speed of the Fourdrinier wire is about 750 fpm (feet per minute).

The embryonic wet web is transferred from the Fourdrinier wire at a fiber consistency of about 24% at the point of transfer, to a belt, such as a patterned belt through-air-drying resin carrying fabric. In the present case, the speed of the patterned through-air-drying fabric is approximately the same as the speed of the Fourdrinier wire. In another case, the embryonic wet web may be transferred to a patterned belt and/or fabric that is traveling slower, for example about 20% slower than the speed of the Fourdrinier wire (for example a wet molding process).

Further de-watering is accomplished by vacuum assisted drainage until the web has a fiber consistency of about 30%.

While remaining in contact with the patterned belt, the web is pre-dried by air blow-through pre-dryers to a fiber consistency of about 65% by weight.

After the pre-dryers, the semi-dry web is transferred to a Yankee dryer and adhered to the surface of the Yankee dryer with a sprayed creping adhesive. The creping adhesive is an aqueous dispersion with the actives consisting of about 75% polyvinyl alcohol, and about 25% CREPETROL® R6390. Optionally a crepe aid consisting of CREPETROL® A3025 may be applied. CREPETROL® R6390 and CREPETROL® A3025 are commercially available from Ashland Inc. (formerly Hercules Inc.). The creping adhesive is diluted to about 0.15% adhesive solids and delivered to the Yankee surface at a rate of about 2 #adhesive solids based on the dry weight of the web. The fiber consistency is increased to about 97% before the web is dry creped from the Yankee with a doctor blade.

In the present case, the doctor blade has a bevel angle of about 45° and is positioned with respect to the Yankee dryer to provide an impact angle of about 101° and the reel is run at a speed that is about 15% faster than the speed of the Yankee. In another case, the doctor blade may have a bevel angle of about 25° and be positioned with respect to the Yankee dryer to provide an impact angle of about 81° and the reel is run at a speed that is about 10% slower than the speed of the Yankee. The Yankee dryer is operated at a temperature of about 177° C. and a speed of about 800 fpm. The fibrous structure is wound in a roll using a surface driven reel drum having a surface speed of about 656 feet per minute.

The fibrous structure may be subsequently converted into a two-ply paper towel product (an article of manufacture) having a basis weight of about 45 to 54 g/m².

Table 1 below shows various comparative examples of fibrous structures, for example absorbent fibrous structures; namely, paper towels (such as Bounty® paper towels commercially available during 2014) without soil adsorbing agent (C-1 to C-4) and with soil adsorbing agent (SA1 to SA17).

TABLE 1

| | Soil | | | | | |
|---|---|---|---|---|---|---|
| | Adsorbing | | Soil | | | |
| | Agent | | Retention | (Density | | |
| | Add-on | Detackifier | (mg/g of | reading | (Density | |
| | Rate | Add-On | fibrous | average of | reading of | Probe Tack |
| Sample | (#/ton) | (#/ton) | structure) | 4 mirrors) | mirror 2) | (mg * cm/cm²) |
| C-1 | 0 | 0.00 | | −1.36 | −1.23 | 129 |
| C-2 | 0 | 0.00 | 107 | −1.47 | −1.43 | 75 |
| C-3 | 0 | 0.00 | 125 | −1.05 | −1.03 | — |
| C-4 | 0 | 0.00 | 94 | — | — | — |
| SA-1 | 1.0 | 0.00 | 220 | −0.34 | −0.13 | 818 |
| SA-2 | 1.0 | 0.00 | 203 | −1.04 | −1.03 | 771 |
| SA-3 | 1.0 | 0.00 | 213 | — | — | — |
| SA-4 | 1.0 | 0.00 | 212 | — | — | — |
| SA-5 | 1.8 | 0.00 | 219 | −0.82 | −0.66 | 1249 |
| SA-6 | 1.8 | 0.00 | 212 | −0.44 | −0.32 | 1230 |
| SA-7 | 1.8 | 0.00 | 229 | −0.33 | −0.27 | 851 |
| SA-8 | 1.8 | 0.00 | 221 | −0.70 | −0.57 | 1263 |
| SA-10 | 1.8 | 0.00 | — | −0.76 | −0.68 | — |
| SA-11 | 1.8 | 0.00 | 224 | −0.25 | −0.18 | 1109 |
| SA-12 | 1.8 | 0.00 | 211 | −0.33 | −0.20 | 978 |
| SA-13 | 1.8 | 0.00 | 226 | −0.35 | −0.33 | 858 |
| SA-14 | 1.8 | 0.00 | 206 | −0.35 | −0.25 | 380 |
| SA-15 | 1.8 | 0.00 | 221 | −0.35 | −0.28 | 411 |
| SA-16 | 1.8 | 0.00 | — | — | — | 527 |
| SA-17 | 3.0 | 0.00 | — | — | — | — |

Table 2 below shows various inventive examples of fibrous structures, for example absorbent fibrous structures according to the present invention (Inv 1 to Inv 13).

TABLE 2

| | Soil | | Soil | | | | | Soil |
|---|---|---|---|---|---|---|---|---|
| | Adsorbing | | Retention | (Density | (Density | | | Adsorbing |
| | Agent | Detackifier | (mg/g | reading | reading | | | Agent:Detackifier |
| | Add-on | Add- | of | average | of | Probe | Detackifier | Particle |
| | Rate | On | fibrous | of 4 | mirror | Tack | Particle | Count |
| Sample | (#/ton) | (#/ton) | structure) | mirrors) | 2) | (mg * cm/cm²) | Size | Ratio |
| Inv 1 | 1.0 | 0.01 | 208 | — | — | — | 20-40 μm | 6,613,757 |
| Inv 2 | 1.0 | 0.01 | 193 | −0.33 | −0.29 | 891 | — | — |
| Inv 3 | 1.0 | 0.01 | 171 | −1.01 | −1.15 | 175 | — | — |
| Inv 4 | 1.82 | 0.02 | 211 | −0.43 | −0.29 | 989 | 20-40 μm | 6,613,757 |
| Inv 5 | 1.82 | 0.03 | 217 | −0.41 | −0.44 | 1214 | — | 4,776,602 |
| Inv 6 | 1.82 | 0.03 | 193 | −1.16 | −1.1 | 135 | 1 μm | 253 |
| Inv 7 | 1.0 | 0.05 | 219 | — | — | 790 | 20-40 μm | 1,264,395 |
| Inv 8 | 1.82 | 0.09 | 203 | −0.40 | −0.29 | 549 | 20-40 μm | 1,264,395 |
| Inv 9 | 1.0 | 0.10 | 198 | — | — | 772 | 20-40 μm | 582,907 |
| Inv 10 | 1.82 | 0.18 | 209 | −0.30 | −0.27 | 1335 | 20-40 μm | 582,907 |
| Inv 11 | 1.82 | 0.21 | 218 | −0.34 | −0.24 | 307 | <1 μm | 31 |
| Inv 12 | 1.82 | 0.21 | 216 | −0.36 | −0.23 | 340 | 20-40 μm | 582,907 |
| Inv 13 | 1.82 | 0.21 | 217 | −0.39 | −0.38 | 1063 | <1 μm | 72 |

Below are non-limiting examples of fibrous structures according to the present invention and processes for making same.

### Example 1

An example of an emulsion, for example a dewatered inverse emulsion, of the present invention about 50% polyacrylamide-hydroxypropylacrylate (HPA) (1% hydroxypropylacrylate) copolymer (soil adsorbing agent), about 40% alkyl alkylate, for example octyl stearate, (hydrocarbon fluid), about 0.1% of a detackifier (bentonite clay), and about 10% emulsifying and/or inverting surfactants with the branched copolymer polyacrylamide-HPA being in the form of micron size highly coiled particles dispersed in the hydrocarbon fluid is applied directly to a surface of the two-ply paper towel product in the converting operation via an extruder.

The fibrous structure plies and/or two-ply paper towel product may be embossed prior to and/or subsequent to the application of the emulsion.

### Example 2

An example of an emulsion, for example a dewatered inverse emulsion, of the present invention about 25% polyacrylamide-hydroxypropylacrylate (HPA) (1% hydroxypropylacrylate) copolymer (soil adsorbing agent), about 65% hydrocarbon fluid (alkyl alkylate, for example octyl stearate or ethyl hexyl stearate or mixtures thereof), about 0.7% of a detackifier (zinc stearate), and about 9.3% emulsifying and/or inverting surfactants with the branched copolymer polyacrylamide-HPA being in the form of micron size highly coiled particles dispersed in the hydrocarbon fluid is applied directly to a surface of the two-ply paper towel product in the converting operation via an extruder.

The fibrous structure plies and/or two-ply paper towel product may be embossed prior to and/or subsequent to the application of the emulsion.

### Example 3

An example of an emulsion, for example a dewatered inverse emulsion, of the present invention about 50% polyacrylamide-methylenebisacrylamide (MBA) (25 ppm) branched copolymer (soil adsorbing agent), about 40% alkyl alkylate, for example octyl stearate, (hydrocarbon fluid), about 5% of a detackifier (zinc stearate), and about 5% emulsifying and/or inverting surfactants with the branched copolymer polyacrylamide-MBA being in the form of micron size highly coiled particles dispersed in the hydrocarbon fluid is applied directly to a surface of the two-ply paper towel product in the converting operation via an extruder.

The fibrous structure plies and/or two-ply paper towel product may be embossed prior to and/or subsequent to the application of the emulsion.

### Example 4

An example of an emulsion, for example a dewatered inverse emulsion, of the present invention about 25% polyacrylamide (soil adsorbing agent), about 65% hydrocarbon fluid (alkyl alkylate, for example octyl stearate or ethylhexyl stearate or mixtures thereof), about 2.5% of a detackifier (bentonite), and about 7.5% emulsifying and/or inverting surfactants with the polyacrylamide being in the form of micron size highly coiled particles dispersed in the hydrocarbon fluid is applied directly to a surface of the two-ply paper towel product in the converting operation via an extruder.

The fibrous structure plies and/or two-ply paper towel product may be embossed prior to and/or subsequent to the application of the emulsion.

### Test Methods

Unless otherwise specified, all tests described herein including those described under the Definitions section and the following test methods are conducted on samples that have been conditioned in a conditioned room (CTCH room) at a temperature of 23° C.±1.0° C. and a relative humidity of 50%±2% for a minimum of 2 hours prior to the test. All plastic and paper board packaging articles of manufacture must be carefully removed from the paper samples prior to testing. The samples tested are “usable units.” “Usable units” as used herein means sheets, flats from roll stock, pre-converted flats, and/or single or multi-ply products. Except where noted all tests are conducted in such conditioned room, all tests are conducted under the same environmental conditions and in such conditioned room. Any damaged product is discarded. Test samples with defects such as wrinkles, tears, holes, and like are not measured. Samples conditioned as described herein are considered dry samples (such as “dry filaments”) for testing purposes. All instruments are calibrated according to manufacturer's specifications.

### Probe Tack Test Method

This method quantifies the moist adhesive energy (mg*cm/cm²) required to separate two sheets after being pressed together in a moist, foggy localized environment, under prescribed conditions detailed here. Sheets are pre-conditioned for a minimum of 2 hours and tested in a laboratory maintained at 23° C. (+/−1° C.) and 50% (+/−2%) relative humidity.

The equipment and materials used in performing this measure are as follows:
Thwing-Albert EJA Vantage with compression/softness fixtures and MAP-3 software (or equivalent)
Abrasion-Resistant Natural Latex Rubber (0.020 inches thick)
O-ring, 1⅛″ ID, 1⅜″OD, round cross-section shape, elastic rubber
Brass Flat Washer, 1½″ Screw Size, 3½″ OD, 0.12″-0.19″ Thick
Venta-sonic Ultrasonic Humidifier (model VS-205 or similar), set to “Cool” mist, on highest “Power Spray” knob setting, and highest “Humidity” knob setting.
Super-Flexible Duct Hose for Fumes 2″ ID×2 3/16″ OD, Blue, 5 ft. Length
   The Thwing-Albert (14 W. Collings Ave., West Berlin, N.J.) EJA Vantage Compression/Softness Tester (model 1750-2005 or similar) is equipped with a 2500 g load cell (force accuracy is +/−0.25% when measuring value is between 10%-100% of load cell capacity, and 0.025% when measuring value is less than 10% of load cell capacity), a 1.128 inch diameter steel pressure foot (one square inch cross sectional area) which is aligned parallel to the steel anvil (2.5 inch diameter). Thwing-Albert software (MAP version 3) controls the motion and data acquisition of the instrument.

A 1.128 inch diameter circular piece of the latex rubber material is adhered to the bottom face of the compression foot using one smooth layer (not tape overlapping) of thin doubled sided tape (Scotch brand permanent cat. 665, or similar), positioning the rubber material such that it completely and smoothly covers the compression foot surface.

The load cell is then ‘zeroed’ (using the software) to 0+/−0.5 grams of force. The pressure foot is then slowly lowered until it makes contact with the steel anvil, achieving a force of 10+/−2 grams. The pressure foot is then moved 3.0 cm up from this position—this new position is then set to zero (using the Map software) and the starting position for the test.

The test sheets are prepared as follows. For a typical paper towel where the sheet width is approximately 10-11 inches, the sheet(s) are cut into thirds along the machine direction (MD), resulting in sections of approximately 3-4 inches wide for each cross-machine direction (CD) position. Each CD section is then cut again, this time along the CD, to create two pieces: one 3-4 inch square (to be attached to the compression foot) and another with a length of 3-8 inches (to be placed on top the anvil, beneath the pressure foot). When complete, there should be (for a typical paper towel width of 10-11 inches) 3 sets of test samples (2 pieces each). For products that are narrower or wider than typical paper towel described here, the number of test sample sets would be calculated by the product width (CD, in inches) divided by 3 inches, and rounded down to the nearest integer. If testing both sides (outside face and inside face) of the sheets, repeat the sample preparation described above to produce another group of samples for testing the opposing side. For clarity, only the outside face (against another outside face) of the sheets will be described in testing below, but the inside (against another inside face) would be performed in the same manner.

Using the first test sample set, center the square piece, with its outside face pointing downward, below the pressure foot, then wrap it around the pressure foot, without physically touching the portion of the sheet that will be contacting the other sheet (that will be setting on the anvil). Use the elastic rubber O-ring to hold the square test piece onto the pressure foot, with enough tension on the sheet to keep it in smooth, close contact with the pressure foot test surface.

Place the other piece from the first test sample set, with its outside facing upwards, on top the anvil, centered below the pressure foot. Again, do not physically touch the region of the sheet that will be in contact with the other sheet (now attached on the pressure foot). Place the brass flat washer weight on top of the sheet, with its hole (≈1.56 inches in diameter) centered below the pressure foot (such that the pressure foot is at least 0.1 inches away from any edge of the inner diameter of the washer). A heavier weight may be used if needed to hold sample in place during the test.

After ensuring the ultra-sonic humidifier is clean and in good working order, fill its reservoir tank with room temperature (23 C) deionized (DI) water. The DI water used must be fresh, not exposed to the environment for more than 24 hours, and the reservoir tank rinsed out and cleaned every 24 hours. Attach one end of the flexible duct hose into the humidifier opening (where the fog comes out). Turn on the humidifier, always using the cool mist setting, the highest humidity setting, and the highest power output flow level setting, and ensure that no fog leaks out at the hose connection point, and with a steady stream of fog exiting the other end of the duct hose. With a steady stream of fog flowing from the duct hose, position the hose end about 2 inches from the test sample pieces, centered between the ≈3 cm gap between them, at a slight downward angle, so that the fog engulfs both the upper and lower paper samples as much as possible. After 15+/−1 seconds, press the ‘Start’ button on the Map software to initiate the test. Do not move the fog hose, but rather continue to apply fog while test runs initially and compression foot moves down. The fog hose is moved away from the sample after the upper and lower sheet sections are in contact with a pressure greater than 300 g/in².

The Map software is programmed to do the following actions after the start button is pressed. First, the load cell is re-zeroed, followed by a pause of one second. The pressure foot is then moved downward at a speed of 30 cm/min until the software realizes a force of at least 20 grams from the load cell (which means the pressure foot and upper sheet sample has made initial contact with the lower sheet sample). At this point, the speed is reduced to 1 cm/min until the force reaches at least 2300 grams. The pressure foot then stops its movement, and waits exactly 5 seconds, after which the pressure foot moves upward at a speed of 20 cm/min. Force and position data are collected and recorded by the software during this upward movement (back to the home position) at a rate of 50 points per second.

After the test is completed, the software calculates the adhesive energy result from the test (units: mg*cm/cm²) as follows. As stated earlier, analysis data is only recorded during the upward movement of the pressure foot; thus, the initial forces of the data array (consisting of position and force) is near 2000 grams (when the probe position is near −3 cm, sheets in contact with each other), which falls rapidly as the pressure foot pulls away and the two sheets become separated. Eventually, a negative force is observed, and after the two sheets are completely separated, the force is approximately zero until the data array ends and the probe reaches its home (zero) position.

First, the position readings (cm) in the array are inverted (multiplied by −1), so that pressure foot positions below the home (zero) position are positive (i.e., decreasing in magnitude as the probe moves upward). Next, in order to obtain an accurate baseline force reading after the two sheets are completely separated from each other, the force data is averaged from 1.8 to 2.05 cm from the home position (however, if the sheets are still connected within this distance range, this range must be moved higher up, closer to zero (home position)). This average baseline force is then subtracted from all the force readings in the array.

Next, the array is reduced to only the points to be used in calculating adhesive energy. This new array starts with the first negative force point (after sheet to sheet contact) and continues until a positive force point occurs, with this new array ending with the last negative force point before such (positive) point. Thus, the array now consists of only negative forces. These negative forces are then inverted to positive (by multiplying by −1), and the area under the curve (where x-axis is position (cm) and y-axis is force (g)) is calculated via numerical integration. The result has units of g*cm, which is then divided by the contact area, which in this case is 6.45 cm² (1.00 in²), then converted to mg*cm/cm² by multiplying by 1000.

The tested samples are then removed, the probe and anvil are dried off from any residual moisture present, and the next sample set is tested in the same manner as described. For a typical paper towel sample (approximately 11 by 11 inches), 3 test results are produced for the outside face of the sheet (at 3 positions across the CD), and, if necessary 3 test results from the inside face of the sheet (in the same manner, across the CD, but with the inside faces contacting each other).

### Accelerated and Stress Aging Procedures

Finished Product stability is defined as the ability of the Finished Product to deliver its intended performance after subjection to the normal range of storage, delivery, and retail conditions. Finished product rolls were packaged using 0.6 mil low density polyethylene film (a proprietary film, Extrel EX1560 available from Tredegar Corporation for this limited purpose) following the procedure detailed below:
1. Cut a 2×3 ft section of 0.6 mil low density polyethylene film.
2. Lay two finished product rolls of paper towels on poly film about 4 inches from the edge of the film such that the rolls are aligned with the 3 ft dimension, and fold poly along the length of the poly over top of the length of the rolls.
3. Heat seal the fold using 3 parallel seals ⅓ inch between each parallel line to insure an effective seal along the length of the rolls.
4. Heat seal on one end about an inch from the end of the poly. This forms a “sock” around the two rolls.
5. Taking care to minimize the volume of air that remains within the finished package, heat seal the final end an inch from the final edge of the 3 ft length of poly forming an airtight seal around the rolls.

Packages containing samples to be tested under this test are conditioned in as follows.

Accelerated Aging (40° C.+/−2°, 75% RH+/−5% for 3 months);

Stress Aging (50° C.+/−2°, 60% RH+/−5% for 2 weeks, optionally extended to 3 weeks);

Samples are taken for testing by removing the package from the conditioned room, cutting the end of the package near as possible to the heat seal, remove the rolls, remove 2 sheets from the outside of the rolls and discard, remove 4 full size sheets for mirror cleaning testing and 1 additional sheet for soil retention. Place rolls back into package, and heat seal the top where it was cut and place back into conditioned room for additional aging if necessary.

### UL Viscosity Test Method

### 1) Reagents and Equipment

a) NaCl,
b) Deionized water,
c) 9 moles Ethoxylated Nonyl Phenol (for example SYNPERONIC NP9 from ICI surfactant),
d) Mechanical stirrer fitted with a stainless steel shaft equipped at the end with about 2 cm radius propeller-type blades,
e) 600 mL beaker,
f) Disposable syringes (5 ml, 2 ml and 10 ml)
g) Balance with an accuracy of 0.001 g,
h) Thermometer,
i) 200 μm stainless steel screen.
   2) Preparation of an initial 0.5% polymer solution in water
a) Obtain a clean 600 mL beaker and fill it with 100 g of deionized water,
b) Start stirring with the mechanical stirrer at 500 rpm to create a vortex,
c) Calculate the weight of pure emulsion (W₀) required to obtain 0.5 g of polymer, W₀=50/C
   C is the percentage of active matter in the emulsion
d) Withdraw approximately the weight (W₀) of emulsion into a plastic syringe,
e) Weigh accurately the syringe and record the weight filled (W_{F}),
f) Disperse rapidly the contents of the syringe into the vortex of the beaker,
g) Let stir 30 minutes,
h) Weigh the empty syringe and record the weight empty (W_{E}),
i) Calculate W=W_{E}−W_{E}.
   3) Preparation of a 0.1% solution of polymer in 1 M NaCl
a) Remove the beaker from the stirrer let the shaft and the blade, drain completely over the beaker,
b) Place the beaker on the balance and weigh in accurately:
   i) 0.2 g of ethoxylated nonyl phenol
   ii) (Q_{E}) g of deionized water, where Q_{E}=W×(9.7949×C−1)−100.2,
c) Let it stir again for 5 minutes at 500 rpm,
d) Then add the salt Qₛ in g: let it stir for 5 minutes, where Q_{S}=0.585×W×C,
e) Resulting in a 0.1% solution of polymer in 1 M NaCl,
f) The polymer solution is now ready for measurement after filtration through a 200 μm screen.
   4) In the Case of a High Molecular Weight Emulsion (UL Viscosity greater than 7 cP)
a) Prepare the solution at 0.5% as in step 2.
b) Remove the beaker from the stirrer let the shaft and the blade drain completely over the beaker,
c) Place the beaker on the balance and weight accurately:
   i) 0.2 g of ethoxylated nonyl phenol,
   ii) (Q_{E}) g of deionized water where Q_{E}=W×(9.7949×C−1)−100.2,
d) Let it stir again for 5 minutes at 850 rpm,
e) Then add the salt Q_{S} in g; let it stir for 5 minutes at 850 rpm, where Q_{S}=0.585×W×C
f) Resulting in a 0.1% solution of polymer in 1 M NaCl,
g) The polymer solution is now ready for viscosity measurement after filtration through a 200 μm screen.

### 5) Viscosity Measurement of Polymer Solution

The viscosity is determined by means of a Brookfield viscometer model LVT with the UL adapter and a spindle speed of 60 rpm
a) 16 ml of the solution are placed in the cup, and the temperature is adjusted to 23-25° C. The cup is then attached to the viscometer.
b) Let the spindle turn at 60 rpm until the reading is stable on the dial (about 30 seconds);
c) Read the value indicated on the dial:
   Viscosity (in cP)=(reading−0.4)×0.1

### Basis Weight Test Method

Basis weight of a fibrous structure, such as sanitary tissue product, is measured on stacks of twelve usable units using a top loading analytical balance with a resolution of ±0.001 g. The balance is protected from air drafts and other disturbances using a draft shield. A precision cutting die, measuring 3.500 in±0.0035 in by 3.500 in±0.0035 in is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1 square in stack)×(No.of squares in stack)]

For example,

Basis Weight (lbs/3000 ft²)=[[Mass of stack (g)/453.6 (g/lbs)]/[12.25 (in²)/144 (in²/ft²)×12]]×3000

or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Moisture Content Test Method

The moisture content present in an article of manufacture, such as a fibrous structure is measured using the following Moisture Content Test Method. An article of manufacture or portion thereof (“sample”) is placed in a conditioned room at a temperature of 23° C.±1.0° C. and a relative humidity of 50%±2% for at least 24 hours prior to testing. Each fibrous structure sample has an area of at least 4 square inches, but small enough in size to fit appropriately on the balance weighing plate. Under the temperature and humidity conditions mentioned above, using a balance with at least four decimal places, the weight of the sample is recorded every five minutes until a change of less than 0.5% of previous weight is detected during a 10 minute period. The final weight is recorded as the “equilibrium weight”. Within 10 minutes, the sample is placed into a forced air oven on top of foil for 24 hours at 70° C.±2° C. at a relative humidity of 4%±2% for drying. After the 24 hours of drying, the sample is removed and weighed within 15 seconds. This weight is designated as the “dry weight” of the sample.

The moisture content of the sample is calculated as follows:

$$\% Moisture in sample = 100 \% \times \frac{\begin{matrix}( Equilibrium weight of sample - \\ Dry weight of sample )\end{matrix}}{Dry weight of sample}$$

The % Moisture in sample for 3 replicates is averaged to give the reported % Moisture in sample. Report results to the nearest 0.1%.

### Soil Adsorption Test Method

In order to measure an article of manufacture's Average Soil Adsorption Value the following test is conducted.

Preparation:

A specimen of the article of manufacture, such as a fibrous structure, to be tested is obtained from the central portion of a representative sample of the article of manufacture. The specimen is prepared by cutting a CD strip (extending across the entire CD of the article of manufacture) from an article of manufacture, such as a finished fibrous structure and/or sanitary tissue product sheet (sample) such that the cut CD strip specimen has a length and width resulting in the specimen weighing 0.65 g±0.02 g. The sheet of the sample from which the CD strip specimen is cut may be delineated and connected to adjacent sheets by perforation or tear lines or the sheets of the sample may be individual sheets, such as in the form of individual wipes and/or facial tissues. If connected via perforation or tear lines, then separate one sheet from any adjacent sheet before cutting the CD strip from the sheet. The CD strip specimen needs to be free of perforations and is obtained from a portion of an article of manufacture at least 0.5 inches from any perforations. The specimen is conditioned as described above. The sample weight (W_{Prod}) is recorded to the within ±0.0001 g. A suitable ball-point pen or equivalent marker is used to write the specimen name onto a corner of the specimen.

A centrifuge tube (VWR brand 50 mL superclear ultra high performance freestanding centrifuge tube with flat caps, VWR Catalog #82018-052; or equivalent tube) is labeled with the specimen name and weighed to within ±0.1 mg W_{CT}. Next, 155.0 mg±5.0 mg of a model soil (black todd clay) available from Empirical Manufacturing Co., 7616 Reinhold Drive, Cincinnati, Ohio 45237-3208) is placed into the centrifuge tube. The tube is re-weighed W_{(CT+Soil)} and the model soil weight (W_{Soil}) is determined to nearest 0.2 mg by difference W_{(CT+Soil)}−W_{CT}.

Distilled water, 35 g±0.5 g is added slowly to the centrifuge tube using a suitable dispenser. The distilled water is poured carefully into the centrifuge tube to avoid causing a plume of dust from the model soil. If a plume of dust occurs such that the weight of soil in the tube may be impacted, the tube is discarded and a new tube is prepared. The tube is then re-weighed W(_{CT+Soil+Water)} and the total weight (W_{(Soil Dispersion)} or water plus soil in the centrifuge tube is calculated by subtracting the weight of the centrifuge tube W_{CT} from the W_{(CT+Soil+Water)} and recorded to the nearest 0.2 mg.

A glass petri dish (e.g. VWR 50×35, VWR Catalog #89000-280, or equivalent dish) is labeled and weighed to within 0.1 mg (W_{(Petri Dish)}).

Testing:

A reciprocating shaker is used to disperse the model soil in the water. The model soil must be completely dispersed for the results to be valid. A reciprocating shaker (IKA Works HS 501 digital reciprocating shaker, number 2527001, with a Universal attachment, number 8000200, or equivalent shaker) is set to 300±3 cycles per minute. The capped centrifuge tube containing the model soil and water is mounted in the shaker and shaken for 30 seconds to obtain a uniform dispersion of the soil in the water (soil dispersion).

The specimen is loosely folded along its transverse centerline with an accordion style (paper fan) folding technique. This folding technique keeps the sample from being too tightly folded, which may hinder free flow of water and suspended soil over all surfaces of the article the thus efficiency of the specimen to adsorb the soil. The folded sample is fully immersed into the soil dispersion in the centrifuge tube so that the folds run parallel to the length of the centrifuge tube. The tube is immediately re-capped and shaken in the reciprocating shaker for 30+/−1 seconds with the length axis of the centrifuge tube parallel to the motion of the reciprocating shaker.

Immediately after shaking, the folded specimen is carefully removed over the glass petri dish using laboratory tweezers. Care must be taken to ensure that greater than 95% of the soil dispersion is kept either in the original centrifuge tube or corresponding glass petri dish. The soil dispersion is wrung (removed) from the specimen using a “wringing” motion and collected in the glass petri dish. Once the soil dispersion has been removed from the specimen, the specimen is discarded. The remaining soil dispersion is poured from the centrifuge tube into the glass petri dish after swirling the mixture to re-disperse model soil into water, thereby ensuring that no model soil is inadvertently left behind in the centrifuge tube. The glass petri dish containing the model soil/water mixture is weighed to within ±0.1 mg W_{(Petri Dish+Soil Dispersion)}. The weight of soil dispersion recovered W_{(Recovered Soil Dispersion)} is calculated by subtracting the weight of the glass petri dish W_{(Petri Dish)} from the W_{(Petri Dish+Soil Dispersion)}. The glass petri dish is then placed into a vented laboratory drying oven at 105° C. until the sample of residual soil is fully dry. The W_{(Recovered Soil Dispersion)} should be >95% of the W_{(Soil Dispersion)}. If it is not, then re-run.

Once the sample is dry, the glass petri dish containing the dried model soil is removed from the oven and placed in a desiccator until cool and then re-weighed to within ±0.1 mg W_{(Petri Dish+Residual Dry Soil)}. The weight of residual soil W_{(Residual Soil)} is calculated by subtracting the weight of the glass petri dish W_{(Petri Dish)} from W_{(Petri Dish+Residual Dry Soil)} and recorded to the nearest 0.2 mg.

### Calculations:

To calculate the amount of residual model soil W_{(Residual Soil)} left in the glass petri dish, the following equation is used:

W_{(Residual Soil)}=W_{(Petri Dish+Residual Dry Soil)}W_{(Petri Dish)}
Residual model soil weight (W_{(Residual Soil)}) is reported in mg.

To calculate the amount of normalized residual model soil (W_{(Norm Residual Soil)}) left in the glass petri dish, the following equation is used:

W_{(Norm Residual Soil)}=W_{(Residual Soil)}*W_{(Soil Dispersion)}/W_{(Recovered Soil Dispersion)}
Normalized residual soil weight W_{(Norm Residual Soil)} is reported in mg.

To calculate the amount of soil adsorbed by the sample, the following calculation is used:

W_{(Soil Adsorbed)}=(W_{(Soil)}−W_{(Norm Residual Soil)})/W_{(Prod)}

Soil adsorbed in sample W_{(Soil Adsorbed)} is reported as mg soil/g article of manufacture.

The test is performed on three replicates and an Average Soil Adsorption Value (Avg W_{(Soil Adsorbed)}) is calculated for the article of manufacture. These values are measured and calculated for initial Average Soil Adsorption Value of a specimen prior to subjecting the specimen to the Accelerated and Stress Aging Procedures described herein and after subjecting the specimen to the Accelerated and Stress Aging Procedures described herein. Soil Adsorption Value is also referred to herein as mg Soil Retained/gram Paper and its corresponding % Soil Retained (by Paper).

### Mirror Cleaning Test Method

A test stand cart holding 4 individual 28″×28″ mirrors (one on each of the 4 sides) resting on a flat surface, such as a floor, is utilized for the mirror cleaning test. The silver mirror layer is on the back surface of a flat clear glass sheet approximately 5 mm thick. The cart is configured such that the bottom edge of each mirror is approximately 3′ 6″ off the flat surface.

The mirror is prepared for testing by cleaning as follows: 1) Windex® commercially available from SC Johnson (an alkaline composition (pH >9) containing 0.1-1.0% by weight of Ethyleneglycol Monohexylether, 1.0-5.0% by weight of Isopropanol, 0.1% sodium lauryl sulfate, 0.05-28% ammonia, and 90-100% by weight of Water) or equivalent is sprayed (4 full sprays, about 3.5 g of solution) onto the mirror surface which is then spread across the entire surface of the mirror with 2 sheets of a 1-ply paper towel, for example 2010 commercially available Bounty® Basic (folded into quarters) using a circular wiping motion; 2) the mirror surface is then wiped dry and lightly polished with the essentially dry side of the folded 1-ply paper towel; 3) wiping the mirror surface with an additional two sheets of the 1-ply paper towel saturated with deionized water; and 4) using a squeegee in a top to bottom motion to remove all excess deionized water. Steps 3) & 4) may be repeated as necessary to achieve a streak and smudge free mirror surface that has no residual impact on the cleaning performance of subsequent test articles of manufacture. Any suitable absorbent substrate can be used in place of Bounty Basic that is not impregnated with polymers that may be deposited onto the glass surface, which may impact the ease or difficulty of cleaning with subsequent test article of manufacture.

A model soil suspension is prepared by suspending 1% by weight of Black Todd Clay in a 50/50 weight ratio of water/isopropyl alcohol mixture containing 0.05% by weight of 100% soybean oil (viscosity of from 150 cP to 200 cP).

Preparation of 100% cooked soybean oil is as follows. Approximately 200 grams of 100% soybean oil available from Spectrum Chemical Manufacturing Corp., 14422 S. San Pedro St., Gardena, Calif. 90248 is placed in a 1000 mL beaker with stir bar. The soybean oil in the beaker is placed on a hot plate and heated to 204° C. while stirring slowly. Air is added through a glass pipette tip set to bubble continuously through the oil without splashing. The oil is cooked continuously until viscosity, at 25° C.±2.2° C., is between 150 and 200 cP. The color changes to a dark orange. Viscosity is measured using a Cannon-Ubbelohde Viscometer tube #350 available from Cannon Instrument Company, State College, Pa. 16803, or equivalent viscometer. A sample of oil which is near room temperature is added to the viscometer and equilibrated to 25° C. in a constant temperature water bath. The efflux time for the meniscus to pass from the top mark to the bottom mark is measured to within ±0.01 second while allowing the oil to flow through the viscometer tube under gravity. Kinematic viscosity in mm²/s is calculated by multiplying the time in seconds by the calibration constant supplied with the viscometer tube. Separately the fluid density is determined by measuring the weight of a fixed volume of oil using a 25 mL volumetric flask and a 4 place analytical balance. Viscosity in cP can be calculated by multiplying the Kinematic viscosity by density of oil in g/mL. The cooking time will vary depending on quantity, surface area and air flow through the oil.

The following procedure is used to apply model soil to the clean mirror surfaces. The target amount of model soil sprayed is 44 g±2.5 g. A spray bottle, part #0245-01 available from www.SKS-bottle.com or equivalent spray bottle is used to spray the model soil suspension onto the mirror surface. Fill the spray bottle to within about 0.5 to 1 inch of the top with the model soil suspension and weigh to the nearest 0.01 g and record as initial weight. The spray bottle is then manually pressurized as needed to achieve a dispersed spray of fine droplets (about 30 full pumps is recommended). Additional pressurization is required between each mirror (about 10 pumps is recommended). Holding the spray bottle about 1.5 feet from the mirror surface a substantially horizontal sweeping motion is used starting at the top of the mirror surface and working down to the bottom of the mirror surface traversing the mirror surface a total of 8 times while attempting to have relatively even coverage on the mirror surface. After applying the model soil suspension to all 4 mirrors, the spray bottle and remaining contents are weighed to the nearest 0.01 g and recorded as weight after first spray. The mirrors are dried sequentially using a handheld hair dryer. The difference between the initial weight and after first spray is used to adjust the amount of spray applied in a second application to achieve the target amount of 44 g +/−2.5 g. The second application of the model soil suspension is applied to each mirror surface in a circular motion, moving from the outside (approximately 8-10 inches from the side edges) inward toward the center. After drying the second application of model soil suspension the minors are ready to be cleaned with an article of manufacture (“specimen”) to be tested. If the target amount of 44 g+/−2.5 g is missed start over. If the time between soil application and cleaning of the mirrors with a test sample extends past 30 minutes, the mirrors need to be returned to their pristine condition using the procedure defined previously after which the soil application procedure can be repeated.

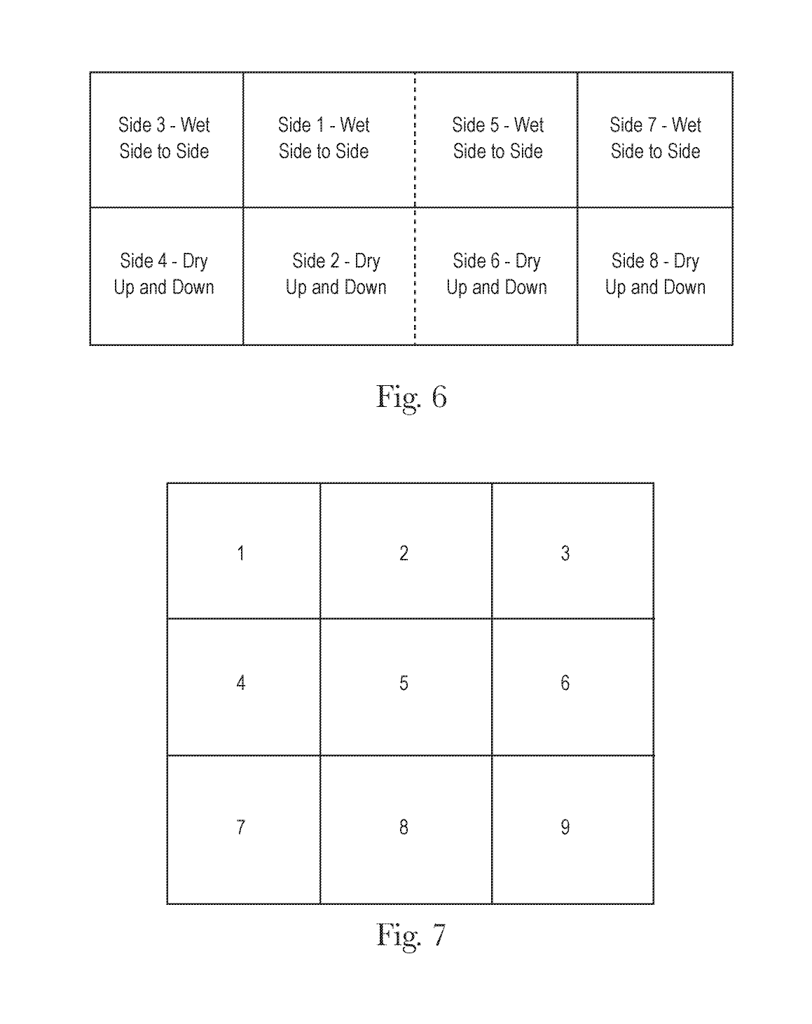

A specimen of a test article of manufacture, for example a paper towel, is prepared as follows. Two sheets of the article of manufacture, for example a paper towel, may be delineated and connected to adjacent sheets by perforation or tear lines or the sheets of the sample may be individual sheets, such as in the form of individual wipes, napkins, and/or facial tissues. If the article of manufacture (fibrous structure), for example a paper towel, is a select-a-size format, then 4 sheets are used. Individual sheet dimensions or in the case of select-a-size two sheets vary by brand from about 8.5″×11″ to 14″×11″ and 2.20 g to 5.2 g. The 2 or for select-a-size 4 sheet specimen is folded in half as shown in FIG. 6 (along perforations if present) with the emboss side out (where applicable). As shown in FIG. 6, the folded sample is then folded in half again with the crease perpendicular to the MD direction and then folded in half again perpendicular to the CD direction such that a sample pad of quarter size sheet that is 8 sheets thick is formed, each sheet may consist of 1, 2 or more individual plies. In the case of fibrous structure with single side application of soil attracting polymer it is important to fold the sheet such that the side containing the soil attracting polymer directly contacts the surface of the mirror. The mirror surface is then treated with 5 full sprays of Windex: two at top; one in the center and two in the lower area of the minor. The weight of Windex sprayed per mirror is about 4.35 g±0.36 g. The minor surface is cleaned by grasping the sample pad in the hand, clamping the substrate between the thumb and index finger and wiping with firm pressure in a cross direction, while holding the sheet (side 1) as flat as possible upon the surface of the mirror and avoiding contacting the minor with any part of the hand using 8 side-to-side passes, such that the full surface of the mirror is contacted. The sample pad is then turned over and the relatively dry back-side (side 2) is used to wipe the mirror surface in an up and down motion, with firm pressure applied using 14 passes, ensuring that the entire surface of the mirror is contacted, again holding the sample pad as flat against the mirror surface as possible. The sample pad is then unfolded once and then folded back on itself revealing a relatively fresh sample pad surfaces to clean the second mirror after application of Windex as discussed above; side 3 (opposite side 1 ) is used for the side-to-side wiping and then turned over to side 4 (opposite side 2) for the up and down wiping. The pad is then unfolded twice to reveal a fresh surface of the specimen. The specimen is then folded in half such that the fresh sample surface is visible with the two used areas of the first sample pad configuration (sides 1 and 3) facing each other and then folded again to clean the third mirror surface after application of Windex as discussed above. Side 5 opposite side 1 and 3 is used first and then turned over to side 6 for the second up and down wiping. The sample pad is unfolded once and then folded back on itself revealing sides 7 and 8 to clean the fourth mirror surface after application of Windex as discussed above. Side 7 opposite sides 5, 3 & 1 is used for the side-to-side wiping and then turned over to side 8 for the final up and down wiping. In each case the wettest part of the folded sample pad is used for the side-to-side wiping and the dryer side for the final up and down wiping.

All 4 mirror surfaces should be cleaned sequentially such that minimal drying of the specimen pad occurs. After cleaning all four mirror surfaces, the mirror surface is permitted to dry and each mirror surface's optical density is measured utilizing an X-Rite 518 Spectrodensitometer. A full calibration as described in the operator's manual is performed. The instrument is set-up per instructions in the manual in Density minus Reference Measurement Mode. The four 28″×28″ mirror surfaces that were cleaned as described above representing a pristine condition. A single reading of a mirror in pristine condition is completed and stored as Ref1 and is used as a reference for all subsequent measurements. A series of 9, 12, or 15 measurements are made on each of the 4 mirrors (3, 4, or 5, respectively, across the top, 3, 4, or 5, respectively, across the middle and 3, 4, or 5, respectively, across the bottom always maintaining a minimum of 3 inches from any edge of the mirror) as shown in FIG. 7 for example. The mirror cleaning test stand is oriented in the lab such that there is no direct overhead lighting and rotated such that the mirror being measured is facing towards an interior wall thus minimizing any influence caused by external lighting differences. Measurements were performed on each of the pristine mirrors. These 9, 12, or 15 individual values are averaged for each mirror. The average values were found to be consistent between mirrors, however, as expected the average shows a small difference from the single point reference. This difference is used to correct all subsequent average values measured. Additionally, average values were determined for mirrors after application of the model soils. After, following the cleaning procedure with the sample specimen, 9, 12, or 15 density readings are performed and an average Densitometer Value is reported for each of the individual mirrors. The Average Mirror Cleaning Densitometer Value is the average of the average Densitometer Values across all 4 mirrors. The orientation of the mirrors and room lighting is such that streaks are not readily visible thus insuring a random location of each measurement taken within the limitations of the 3×3, 3×4, or 3×5 grid described above.

### Volatile Organic Carbon (VOC) Test Method

The VOC content of an article of manufacture, expressed in units of weight of VOC per weight of polymer (soil adsorbing agent(s)), and shall be determined as follows. The VOC content of water in oil emulsions and dewatered emulsions is determined utilizing EPA method 24. Specifically the following procedure was utilized:

% volatiles:
1. Weigh a dry aluminum drying pan utilizing a 4 place analytical balance.
2. Equilibrate sample by gently mixing to insure representative sampling.
3. Add approximately 1 gram of neat material (sample) to the pre-weighed aluminum drying pan and weigh on the 4 place analytical balance.
4. Weight in step 3 minus the weight in step 1 equals the sample weight.
5. Place aluminum drying pan with sample into oven at 105° C. for 1 hour.
6. Remove the aluminum drying pan and dry sample from oven and place in a dessicator to cool.
7. Reweigh aluminum drying pan+dried and cooled sample on 4 place analytical balance.
8. Difference in weight of step 7 minus step 1 equals the residual weight.
9. Residual weight determined in step 8 divided by the sample weight in step 4×100=% solids at 105° C.
10. 100 minus % solids determined in step 9 equals % volatile at 105° C.

% moisture by Karl Fischer:

A Metler DL18 or DL31 Karl Fischer specific titrator, with a two component reagent system and a Mettler DM143-SC double platinum pin electrode is used to measure % moisture. Alternatively, moisture can be determined by ASTM D 4017.

% VOC:

% VOC=% Volatiles−% Moisture.

### Charge Density Test Method

If one has identified or knows the soil adsorbing agent in and/or on an article of manufacture, then the charge density of the soil adsorbing agent can be determined by using a Mutek PCD-04 Particle Charge Detector available from BTG, or equivalent instrument. The following guidelines provided by BTG are used. Clearly, manufacturers of articles of manufacture comprising soil adsorbing agents know what soil adsorbing agent(s) are being included in their articles of manufacture. Therefore, such manufacturers and/or suppliers of the soil adsorbing agents used in the articles of manufacture can determine the charge density of the soil adsorbing agent.

1. Start with a 0.1% solution (0.1 g soil adsorbing agent+99.9 g deionized water).

Preparation of dilute aqueous solutions in deionized water from inverse or dewatered inverse emulsions are performed as instructed by the supplier of the emulsions and is well known to one of ordinary skill in the art. Depending on the titrant consumption increase or decrease soil adsorbing agent content. Solution pH is adjusted prior to final dilution as charge density of many additives is dependent upon solution pH. A pH of 4.5 is used here for cationic polymers and between 6-7 for anionic polymers. No pH adjustment was necessary for the anionic polymers included in this study.

2. Place 20 mL of sample in the PCD measuring cell and insert piston.

3. Put the measuring cell with piston and sample in the PCD, the electrodes are facing the rear. Slide the cell along the guide until it touches the rear.

4. Pull piston upwards and turn it counter-clock-wise to lock the piston in place.

5. Switch on the motor. The streaming potential is shown on the touch panel. Wait 2 minutes until the signal is stable.

6. Use an oppositely charged titrant (for example for a cationic sample having a positive streaming potential: use an anionic titrant). Titrants are available from BTG consisting of 0.001N PVSK or 0.001N PolyDADMAC.

7. An automatic titrator available from BTG is utilized. After selecting the proper titrant, set the titrator to rinse the tubing by dispensing 10 mL insuring that all air bubbles have been purged.

8. Place tubing tip below the surface of the sample and start titration. The automatic titrator is set to stop automatically when the potential reaches 0 mV.

9. Record consumption of titrant, ideally, the consumption of titrant should be 0.2 mL to 10 mL; otherwise decrease or increase soil adsorbing agent content.

10. Repeat titration of a second 20 mL aliquot of the soil adsorbing agent sample.

11. Calculate charge demand (solution) or charge demand (solids);

$$Charge demand ( eq \text{/} L ) = \frac{\begin{matrix}V titrant used ( L ) \times \\ Conc . of titrant in Normality ( eq \text{/} L )\end{matrix}}{Volume of sample titrated ( L )}$$

$$Charge demand ( eq \text{/} g ) = \frac{\begin{matrix}V titrant used ( L ) \times \\ Conc . of titrant in Normality ( eq \text{/} L )\end{matrix}}{\begin{matrix}Wt . solids of the sample \\ or its activate substance ( g )\end{matrix} }$$

The charge density (charge demand) of a soil adsorbing agent is reported in meq/g units.

### Acrylamide Monomer Test Method:

Acrylamide is prepared for analysis from an article of manufacture by extracting 1 gram of the article with 20 mL of Analytical Reagent Grade Water (ARW). The analyte and internal standard (¹³C₃-acrylamide) are subjected to reversed-phase high performance chromatographic (RP-HPLC) analysis on a Phenomenex Synergi Hydro-RP column (2.1×150 mm, 4 μm, 80 Å). Detection and quantification is by tandem mass spectrometry (MS/MS) operating under multiple reaction monitoring (MRM) conditions. Calibration standards (STD) prepared in ARW are used to quantitate Quality Control (QC) samples and unknown specimens. The nominal range of quantitation is 0.5 to 100 ng/mL. The assay requires a 0.2 mL aliquot of ARW extract of article. Specimen concentrations are determined by back-calculation using a weighted (1/x²) quadratic calibration curve generated from neat STDs.

### Reagents:

1. Acrylamide. Sigma-Aldrich,
2. ¹³C₃-Acrylamide. Isotec.
3. Methanol (MeOH). EMD, HPLC grade, cat #MX0475P-1; or equivalent.
4. Acetonitrile (ACN). EMD, HPLC grade, cat #AX0145; or equivalent.
5. Formic Acid. EMD, cat #11670; or equivalent.
6. Analytical Reagent Grade Water (ARW); or equivalent.
7. Needle Wash 1: ARW with 0.1% FA. Expires after 3 months stored at room temperature. (Example: Combine 1000 mL of ARW with 1 mL formic acid.)
8. Needle Wash 2: ACN with 0.1% FA. Expires after 6 months stored at room temperature. (Example: Combine 1000 mL of acetonitrile with 1 mL formic acid.)
9. Mobile Phase A: 4% MeOH/96% ARW (v/v) with 0.1% FA. Expires after 3 months stored at room temperature. (Example: Combine 960 mL of ARW and 40 mL of MeOH with 1 mL formic acid.)
10. Mobile Phase B: 95% MeOH/5% ARW (v/v) with 0.1% FA. Expires after 3 months stored at room temperature. (Example: Combine 950 mL of Me0H and 50 mL of ARW with 1 mL formic acid.)

### Apparatus:

1. Electronic Dispensing Pipettes (EDP), manual pipettes; or equivalent.
2. HPLC pump. Shimadzu Model SCL-10A vp system controller & LC-10AD vp pumps with Gilson Model 811C mixer (65 μL volume); or equivalent.
3. Mass spectrometer. Sciex API 4000; or instrument meeting equivalent sensitivity requirements using analyst software.
4. Valco Two Position Actuator; or equivalent.
5. Analytical Column. Phenomenex Synergi Hydro-RP column (2.0×150 mm, 4 μm, 80 Å).
6. 20 mL Scintillation Vials, Wheaton, catalog #986541; or equivalent.
7. 50 mL polypropylene centrifuge tube.
8. Multi-Tube Vortexer. VWR brand; or equivalent.
9. Autosampler. CTC Analytics HTS PAL, Leap Technologies; or equivalent.
10. 1.3 mL Round Well Round Bottom Polypropylene 96-well Injection Plates. Microliter cat #07-3000, VWR cat #100532-120; or equivalent.
11. 1.3 mL Sealing Mat for Deep 96 Round Well Collection Plates. Axygen Scientific cat #AM-75OUL-RD; or equivalent.

### Procedure:

### 1. Preparation of Acrylamide Calibration Standards (STD) and Quality Control (QC) Samples

Separate Stock solutions should be prepared for STD and QC samples to verify correctness of weighing. Standards and QC samples are prepared fresh daily.

1.1. Acrylamide Standard Stock (STD Stock) and QC Stock (QC Stock) Solutions (1.00 mg/mL):
Prepare separate two 1.00 mg/mL stocks of the compound, one for standards (STD Stock) and the other for QCs (QC Stock).
Typical Preparation: Using the appropriate Analytical Reference Standard weigh approximately 5-20 mg into a Scintillation Vial and record the weight. Add calculated volume of water determined in Equation 1 to the vial. An ultrasonic cleaner may be used to assist dissolving the compound. Mix well and store at room temperature (about 23.0° C.). The stability is to be determined.

$$Equation 1 \text{:}$$

$$Volume to add ( ml ) = \frac{Mass of material ( mg )}{1.00 mg \text{/} mL concentration} \times \% Purity$$

Where: Purity=Decimal % purity assigned to the Analytical Reference Standard multiplied by any salt correction factor.

1.2. Standard (STD) Solutions and QC Solutions:
With an adjustable volume pipette, add the appropriate amount of each Spiking Solutions, according to Table 3 below into an appropriate scintillation vials to make the indicated ng/mL STD or QC solutions. For makeup solution, dilute using water. Mix well and store at room temperature until use.

Preparation of Calibration Standard Curve and QC Samples.

TABLE 3

| | Initial | Initial | | | Final | |
|---|---|---|---|---|---|---|
| Solution | Conc | Volume | Solution | Final Conc | Volume | |
| Used | (ng/mL) | (mL) | Made | (ng/mL) | (mL) | Makeup |
| Stock | 1,000,000 | 0.10 | IMD | 10,000 | 10 | 9.90 |
| IMD | 10,000 | 0.10 | STD 9 | 100 | 10 | 9.90 |
| IMD | 10,000 | 0.08 | STD 8 | 80 | 10 | 9.92 |
| IMD | 10,000 | 0.04 | STD 7 | 40 | 10 | 9.96 |
| IMD | 10,000 | 0.02 | STD 6 | 20 | 10 | 9.98 |
| STD 9 | 100 | 1.00 | STD 5 | 10 | 10 | 9.00 |
| STD 7 | 40 | 1.00 | STD 4 | 4 | 10 | 9.00 |
| STD 6 | 20 | 1.00 | STD 3 | 2 | 10 | 9.00 |
| STD 5 | 10 | 1.00 | STD 2 | 1 | 10 | 9.00 |
| STD 4 | 4 | 1.25 | STD 1 | 0.5 | 10 | 8.75 |
| IMD | 10,000 | 0.075 | HQC | 75 | 10 | 9.925 |
| HQC | 75 | 2.0 | MQC | 15 | 10 | 8.00 |
| MQC | 15 | 1.0 | LQC | 1.5 | 10 | 9.00 |

2. Preparation of ¹³C₃-Acrylamide Internal Standard ISTD Solution.

2.1. ˜1.00 mg/mL Internal Standard Solution ¹³C₃-Acrylamide (ISTD Stock):
Prepare a 1.00 mg/mL Stock Solution of compound.
Typical Preparation: Weigh approximately 5 to 10 mg of compound in to Scintillation Vial and record the weight. Add calculated volume of water determined in Equation 1 to the vial. Mix well. An ultrasonic cleaner may be used to assist dissolving the compound. Store at 4° C. until use.

2.2. ˜10,000 ng/mL Internal Standard Intermediate Solution (ISTD IMD):
Prepare a ˜10,000 ng/mL Internal Standard Solution (W-ISTD) of ¹³C₃-Acrylamide by diluting 0.1 mL of the Stock Internal Standard Solution (2.1) with 9.9 mL of water. Mix well. Store at 4° C. until use.

2.3. ˜100 ng/mL Working Internal Standard Solution (W-ISTD):
Prepare a ˜100 ng/mL Working Internal Standard Solution (W-ISTD) of ¹³C₃-Acrylamide by diluting 0.1 mL of Internal Standard Intermediate Solution (2.2) with 9.9 mL of water. Mix well. Store at 4° C. until use.
   4. Batch Preparation: A study batch includes bracketing calibration standards, quality control (QC) samples, blanks, and study specimens. At least one zero standard is placed after a high standard, high QC or suspected high study specimen.

4.1. Original Samples and Matrix Blank: Weigh approximately 1 gram of an article of manufacture into a 50 mL polypropylene centrifuge tube and 20 mL of water is added. Vortex for approximately 10 minutes. For paper towel, weigh 1 sheet of paper towel into a suitable container and 100 mL of water is added. Vortex for approximately 10 minutes. For polymer solution, weigh approximately 10 mg of polymer solution and dilute it with water to an appropriate concentration.

4.2. Working Internal Standard: Add 0.050 mL of the Working Internal Standard solution (W-ISTD as prepared in Section 2.2) into each well of a 96-well plate except for the Reagent Blank.

4.3. Reagent Blank: Add 0.250 mL of water to all designated wells for reagent blanks and STD 0.

4.4. STD Samples. Add 0.200 mL of each calibration standard solution (STD 1-STD 9 prepared in Section 1.2) to its designated wells.

4.5. QC Samples. Add 0.200 mL of each quality control calibration solution (LQC, MQC and HQC prepared in Section 1.2) to its designated wells.

4.6. Samples. Add 0.200 mL of each sample to its designated wells.

4.7. Cover the plate with sealing mat and vortex the plate for approximately 10 seconds.

4.8. Analyze the samples by HPLC-MS/MS.

### Analysis by HPLC-MS/MS

Using the instrument parameters listed below in Tables 4-6:

### HPLC-MS/MS Parameters

### API 4000 Sciex MS with Shimadzu Pump and Leap Injector

TABLE 4

| Flow rate | 0.30 mL/min |
|---|---|
| Injection volume | 10 μL* |
| Total Run time | 5 min |
| HPLC Column Temperature | Ambient |
| Pre Clean with Wash 1 | 2 |
| Pre Clean with Wash 2 | 0 |
| Post Clean with Wash 1 | 1 |
| Post Clean with Wash 2 | 1 |
| Valve Clean with Wash 1 | 1 |
| Valve Clean with Wash 2 | 1 |

*The injection volume may be adjusted to optimize the HPLC-MS/MS sensitivity.

### Gradient

TABLE 5

| Time | Mobile Phase A (%) | Mobile Phase B (%) |
|---|---|---|
| 0.0 | 100 | 0 |
| 2.4 | 100 | 0 |
| 2.7 | 0 | 100 |
| 3.5 | 0 | 100 |
| 3.6 | 100 | 0 |
| 5.0 | 100 | 0 |

TABLE 6

| Time | Divert Valve |
|---|---|
| 0.0 | To Waste |
| 0.5 | To MS |
| 4.5 | To Waste |

Mass Spectrometer Parameters. These are typical operating conditions for the Sciex API 4000 mass spectrometer as shown in Table 7 below. These parameters may be adjusted to optimize the response; however, these parameters must not be adjusted during a run, but rather a consistent set of instrument settings/parameters must be used for each run.

TABLE 7

| Mass Spectrometer: | Sciex API 4000 |
|---|---|
| Ionization mode: | Turbo-Ion Spray-ESI |
| Polarity: | Positive |
| Turbo Temp: | 650° C. |
| CUR: | 30 |
| GS 1: | 75 |
| GS 2: | 75 |
| IS: | 3800 |
| CAD: | 12 |
| EP: | 10 |
| CXP: | 10 |
| Dwell: | 80 |

### Ions Used in MRM Mode

TABLE 8

| | Precursor Ion | Product Ion | | |
|---|---|---|---|---|
| Compound | (m/z) | (m/z) | DP | CE |
| Acrylamide | 71.9 | 55.1 | 36 | 17 |
| ¹³C₃-Acrylamide | 74.9 | 58.1 | 41 | 17 |

The molecular ions listed in Table 8 above may vary by ±0.2 m/z depending upon instrument calibration and optimization.

### Regression Analysis:

A weighted (1/x²) quadratic regression analysis is performed in Analyst for the observed signal (defined here as the peak area ratio of the analyte to its internal standard) as a function of the analyte mass.

### System Suitability Criteria:

Visual inspection will ensure no significant peaks (<20% of the response of the lowest standard) at the retention time of the analyte.
That adequate retention and peak shape is obtained for the analyte and that following the high standard there is not significant carry over in a STD 0 (<20% of the response for lowest standard) for each analyte.

### Standard Curve Acceptance Criteria:

The curve contains at least 5 unique non-zero standards and at least 75% of the standards analyzed must meet the accuracy (% RE) criteria.
% RE of each back calculated standard mass is ±15% (±20% for low standard)

### QC Acceptance Criteria:

At least 67% of the total number of QC's run, and at least 50% of the QC's at each mass level (LQC, MQC & HQC), must meet the following accuracy acceptance criteria.
   The % RE must be less than or equal ±15% at each QC level.

### Bulk Viscosity Test Method

The purpose of this bulk viscosity test is to measure the viscosity of emulsions, such as dewatered emulsions, themselves.

### Equipment:

Brookfield viscometer model LUT (or LVF) or equivalent;
Constant temperature bath at 25° C.;
250 mL capped bottles
Thermometer

### Procedure:

Place 250 mL of the neat emulsion in a clean, dry bottle and close with cap.
Place bottle in a constant temperature bath set at 25° C. and allow the sample to equilibrate at 25° C. Immediately thoroughly mix the sample and then immediately, while sample is at 25° C., test the sample.
Measure the viscosity with the Brookfield viscometer using the suitable spindle at 30 rpm as set forth below in Table 9.
   Let the spindle turn until the index is providing a stable reading (about 30 seconds).

Viscosity (in cps)=value×appropriate factor

TABLE 9

| Spindle speed | LV1 | LV2 | LV3 |
|---|---|---|---|
| 30 rpm | X 2 | X 10 | X 40 |

### CRT Test Method

The absorption (wicking) of water by an absorbent fibrous structure (sample) is measured over time. A sample is placed horizontally in the instrument and is supported by an open weave net structure that rests on a balance. The test is initiated when a tube connected to a water reservoir is raised and the meniscus makes contact with the center of the sample from beneath, at a small negative pressure. Absorption is allowed to occur for 2 seconds after which the contact is broken and the cumulative rate for the first 2 seconds is calculated. This method and equipment is similar to that described in 2011 PaperCon proceedings “Paper Towel Absorptive Properties and Measurement using a Horizontal Gravimetric Device” David Loebker and Jeffrey Sheehan.

### Apparatus

Conditioned Room-Temperature is controlled from 73° F.±2° F. (23° C.±1° C.). Relative Humidity is controlled from 50%±2%

Sample Preparation-Product samples are cut using hydraulic/pneumatic precision cutter into 3.0 inch diameter circles.

Capacity Rate Tester (CRT)-The CRT is an absorbency tester capable of measuring capacity and rate. The CRT consists of a balance (0.001 g), on which rests on a platform with a woven grid (using nylon monofilament line having a 0.014″ diameter) placed over a small reservoir with a delivery tube in the center. This reservoir is filled by the action of solenoid valves, which help to connect the sample supply reservoir to an intermediate reservoir, the water level of which is monitored by an optical sensor. The top of the woven grid of monofilaments is 2.0 mm higher than the water surface in the intermediate reservoir, controlled by adjusting the height of water in the intermediate reservoir.

Software-LabView based custom software specific to CRT Version 4.2 or later.

Water-Distilled water with conductivity <10 μS/cm (target <5 μS/cm) @ 25° C.

For this method, a usable unit is described as one finished product unit regardless of the number of plies. Condition all samples with packaging materials removed for a minimum of 2 hours prior to testing. Discard at least the first ten usable units from the roll. Remove two usable units and cut one 3.0-inch circular sample from the center of each usable unit for a total of 2 replicates for each test result. Do not test samples with defects such as wrinkles, tears, holes, etc. Replace with another usable unit which is free of such defects.

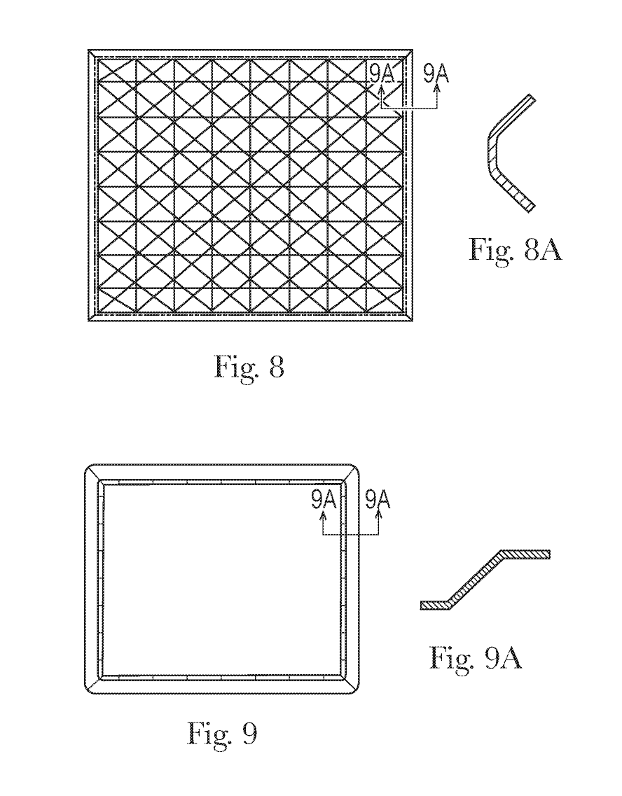

Pre-test Set-up
1. The water height in the reservoir tank is set −2.0 mm below the top of the support rack (FIGS. 8 and 8A) (where the sample will be placed).
2. The supply tube (8 mm I.D.) is centered with respect to the support rack.
3. Test samples are cut into circles of 3.0″ diameter and equilibrated it the CTCH room for a minimum of 2 hours.

Test Description
1. After pressing the start button on the software application, the supply tube moves below the water height in the intermdiate tank to a position such that a small meniscus is formed above the supply tube (about 0.5 to 1 mm above the supply tube opening). This is needed to ensure test initiation. A valve between the intermediate tank and the supply tube is then closed, and the scale is zeroed.
2. The software prompts you to “load a sample”. A sample is placed on the support net (support rack), centering it over the supply tube, and with the side facing the outside of the roll placed downward.
3. Close the balance windows, and press the “OK” button—the software records the dry weight of the circle.

4. The software prompts you to “place cover on sample”. The plastic cover (FIGS. 9 and 9A) is placed on top of the sample, on top of the support net. The plastic cover has a center pin (which is flush with the outside rim) to ensure that the sample is in the proper position to establish hydraulic connection. Four other pins, 1 mm shorter in depth, are positioned 1.25-1.5 inches radially away from the center pin to ensure the sample is flat during the test. The sample cover rim should not contact the sheet. Close the top balance window and click “OK”.
5. The software re-zeroes the scale and then moves the supply tube towards the sample. When the supply tube reaches its destination, which is 0.33 mm below the support net, the valve opens (i.e., the valve between the reserve tank and the supply tube), and hydraulic connection is established between the supply tube and the sample. Data acquisition occurs at a rate of 5 Hz, and is started about 0.4 seconds before water contacts the sample.
6. The test runs for 2 seconds. After this, the supply tube pulls away from the sample to break the hydraulic connection. After waiting 2-3 seconds (giving the balance a chance to settle out), the balance reading is recorded (to the nearest 0.001 grams). This reading is the weight (grams) of water absorbed during the 2 seconds of contact. CRT Rate (g/sec) is calculated by dividing this weight (grams) by two, reported to the nearest 0.001 g/sec.
7. The difference between a Control Sample and a Test Sample can be calculated from their respective CRT Rates from Step 10 and then the percentage change can be determined and reported as CRT Rate Change; for example CRT Rate Change=(Control Rate−Test Rate)/Control Rate*100

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An absorbent fibrous structure comprising a soil adsorbing agent and a detackifier.

2. The absorbent fibrous structure according to claim 1 wherein the absorbent fibrous structure exhibits an average Soil Adsorption Value of about 90 mg soil/g absorbent fibrous structure or greater as measured according to the Soil Adsorption Test Method.

3. The absorbent fibrous structure according to claim 1 wherein the absorbent fibrous structure comprises a plurality of pulp fibers.

4. The absorbent fibrous structure according to claim 1 wherein the absorbent fibrous structure exhibits a moisture level of less than 30% as measured according to the Moisture Content Test Method.

5. The absorbent fibrous structure according to claim 1 wherein the absorbent fibrous structure exhibits an average Mirror Cleaning Densitometer Value of greater than −0.45 as measured according to the Mirror Cleaning Test Method.

6. The absorbent fibrous structure according to claim 1 wherein soil adsorbing agent comprises a branched copolymer.

7. The absorbent fibrous structure according to claim 6 wherein the branched copolymer comprises a monomeric unit derived from an acrylamide compound.

8. The absorbent fibrous structure according to claim 6 wherein the branched copolymer comprises a monomeric unit derived from a methylene bisacrylamide compound.

9. The absorbent fibrous structure according to claim 1 wherein the soil adsorbing agent is present on the absorbent fibrous structure at a level of from about 0.005% to about 5% by weight of the absorbent fibrous structure.

10. The absorbent fibrous structure according to claim 1 wherein the soil adsorbing agent and the detackifier are present in an emulsion.

11. The absorbent fibrous structure according to claim 10 wherein the emulsion is an inverse emulsion.

12. The absorbent fibrous structure according to claim 11 wherein the emulsion is a dewatered inverse emulsion.

13. The absorbent fibrous structure according to claim 10 wherein the emulsion comprises less than 37% by weight of the soil adsorbing agent.

14. The absorbent fibrous structure according to claim 10 wherein the emulsion comprises greater than 0.1% by weight of the detackifier.

15. The absorbent fibrous structure according to claim 10 wherein the emulsion further comprises a hydrocarbon fluid.

16. The absorbent fibrous structure according to claim 10 wherein the emulsion comprises a viscosity of less than 2000 cps as measured according to the Bulk Viscosity Test Method.

17. A multi-ply sanitary tissue product comprising an absorbent fibrous structure according to claim 1.

18. A method for making an absorbent fibrous structure according to claim 1 wherein the method comprises the step of contacting an absorbent fibrous structure with an emulsion comprising a soil adsorbing agent and a detackifier.

19. An absorbent fibrous structure comprising an emulsion comprising a soil adsorbing agent comprising a monomeric unit derived from acrylamide compound and a monomeric unit derived from a hydroxyalkylacrylate compound and a detackifier.

20. An absorbent fibrous structure comprising an emulsion comprising a soil adsorbing agent comprising polyacrylamide and a detackifier.
